(19) United States
(12) Patent Application Publication
(10) Pub. No.: US 2026/0229770 A1
(43) Pub. Date: Aug. 6, 2026

(54) ELECTRONIC DEVICE COMPRISING ANTENNA

(71) Applicant: Samsung Electronics Co., Ltd., Suwon-si (KR)

(72) Inventors: Kookjoo LEE, Suwon-si (KR); Jaeho LIM, Suwon-si (KR); Hojung NAM, Suwon-si (KR); Sungkoo PARK, Suwon-si (KR); Kyungjae LEE, Suwon-si (KR); Soonho HWANG, Suwon-si (KR); Seunghwan KIM, Suwon-si (KR); Kyungmoon SEOL, Suwon-si (KR); Cheolhong SON, Suwon-si (KR); Jaebong CHUN, Suwon-si (KR)

(21) Appl. No.: 19/631,505

(22) Filed: Mar. 27, 2026

Related U.S. Application Data
(63) Continuation of application No. PCT/KR2024/013555, filed on Sep. 6, 2024.

(30) Foreign Application Priority Data
Sep. 28, 2023 (KR) 10-2023-0131275
Nov. 14, 2023 (KR) 10-2023-0157745

(51) Int. Cl. H01Q 3/02

(52) U.S. Cl. CPC H01Q 3/02

(57) ABSTRACT

An electronic device according to an embodiment comprises at least one processor, a memory storing instructions, an antenna, a slidable housing including a first housing part and a second housing part, wireless communication circuitry, and a driving mechanism configured to provide a driving force for sliding the second housing part with respect to the first housing part. The instructions, when executed by the at least one processor, cause the electronic device to control the driving mechanism such that a radiation pattern of the antenna is changed to a state in which the upward directionality is high.

### CROSS-REFERENCE TO RELATED APPLICATION(S)

This application is a continuation application, claiming priority under 35 U.S.C. § 365 (c), of an International application No. PCT/KR2024/013555, filed on Sep. 6, 2024, which is based on and claims the benefit of a Korean patent application number 10-2023-0131275, filed on Sep. 28, 2023, in the Ministry of Intellectual Property (MOIP), and of a Korean patent application number 10-2023-0157745, filed on Nov. 14, 2023, in the Ministry of Intellectual Property (MOIP), the disclosure of each of which is incorporated by reference herein in its entirety.

### BACKGROUND

### 1. Field

The disclosure relates to an electronic device including an antenna.

### 2. Description of Related Art

An electronic device may transmit or receive a signal through an antenna. For example, the electronic device may transmit a signal within a satellite communication frequency band through at least a portion of a conductive portion. Since a satellite is far from the ground, satellite communication efficiency may be improved in a case that a radiation pattern of the antenna of the electronic device has high upward directivity.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device including an antenna.

Additional aspects will be set forth in part in the description which follows and, in part, will be apparent from the description, or may be learned by practice of the presented embodiments.

In accordance with an aspect of the disclosure, an electronic device is provided. The electronic device includes memory including one or more storage media storing instructions, an antenna, a slidable housing including a first housing part and a second housing part slidably coupled to the first housing part, wireless communication circuitry configured to (i) transmit a signal on a designated frequency band to an external electronic device through the antenna or (ii) receive the signal from the external electronic device through the antenna, a driving mechanism configured to provide a driving force for sliding movement of the second housing part with respect to the first housing part, and one or more processors communicatively coupled to the wireless communication circuitry, the memory, and the driving mechanism, wherein the driving mechanism includes a first state, in which a size of a slidable housing formed by the first housing part and the second housing part is minimum, a second state, in which the size of the slidable housing is maximum, and a third state, in which the size of the slidable housing is in between that of the first state and that of the second state, and wherein the instructions, when executed by the one or more processors individually or collectively, cause the electronic device to, based on the wireless communication circuitry performing communication with the external electronic device, identify, from among the first state, the second state, and the third state, a state in which upward directivity of a radiation pattern of the antenna is high, and control the driving mechanism to change a state of the electronic device to the state in which the upward directivity of the radiation pattern of the antenna is high.

In accordance with another aspect of the disclosure, an electronic device is provided. The electronic device includes memory, including one or more storage media, storing instructions, an antenna, wireless communication circuitry configured to communicate with an external electronic device using a signal on a designated frequency band, a foldable housing including a first housing part and a second housing part rotatably coupled to the first housing part, a flexible display including a first portion disposed on the first housing part, a second portion disposed on the second housing part, and a third portion between the first portion and the second portion, a hinge structure rotatably connecting the first housing part and the second housing part with respect to a folding axis, and one or more processors communicatively coupled to the wireless communication circuitry and the memory, wherein the hinge structure is configured to transition the electronic device between a first state, in which a first direction toward which the first portion faces is the same as a second direction in which the second portion faces, a second state, in which the first direction is opposite to the second direction, and a third state, which is between the second state and the first state, and wherein the instructions, when executed by the one or more processors individually or collectively, cause the electronic device to, based on the wireless communication circuitry performing communication with the external electronic device, identify an angle between the first portion and the second portion in which upward directivity of a radiation pattern of the antenna is high, and display on a screen on the flexible display for guiding the angle in which the upward directivity of the radiation pattern of the antenna is high.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2A is a top plan view of an electronic device in a first state according to an embodiment of the disclosure;

FIG. 2B is a bottom view of the electronic device in the first state according to an embodiment of the disclosure;

FIG. 2C is a top plan view of an electronic device in a second state according to an embodiment of the disclosure;

FIG. 2D is a bottom view of the electronic device in the second state according to an embodiment of the disclosure;

FIGS. 3A and 3B are exploded perspective views of an electronic device according to various embodiments of the disclosure;

FIG. 4A is a cross-sectional view of an electronic device in a first state according to an embodiment of the disclosure;

FIG. 4B is a cross-sectional view of an electronic device in a second state according to an embodiment of the disclosure;

FIG. 5A illustrates an electronic device in which a display is omitted according to an embodiment of the disclosure;

FIG. 5B is a block diagram of an electronic device according to an embodiment of the disclosure;

FIG. 5C is a graph representing a radiation pattern of an antenna to a state of an electronic device according to an embodiment of the disclosure;

FIGS. 6A, 6B, and 6C schematically illustrate a flow of a current and an electromagnetic field formed in an electronic device according to various embodiments of the disclosure;

FIGS. 6D and 6E are graphs representing modal significance of a plurality of modes to a frequency with respect to a slidable housing having a certain length according to various embodiments of the disclosure;

FIG. 6F is a graph representing modal significance of a plurality of modes to a slidable housing with respect to a designated frequency according to an embodiment of the disclosure;

FIG. 7 is a graph representing a radiation pattern of an antenna to a slide-out length of a second housing part according to an embodiment of the disclosure;

FIG. 8 is a flow chart representing an operation in which an electronic device controls a driving mechanism according to an embodiment of the disclosure;

FIG. 9A illustrates a relative positional relationship between an electronic device and an external electronic device according to an embodiment of the disclosure;

FIG. 9B is a flow chart representing an operation in which an electronic device identifies a state in which upward directivity is high over time according to an embodiment of the disclosure;

FIG. 9C is a flow chart representing an operation in which an electronic device changes a slide-out length according to an embodiment of the disclosure;

FIG. 10 is a flow chart representing a process in which an electronic device searches for a state in which upward directivity is high according to an embodiment of the disclosure;

FIGS. 11A, 11B, 11C, and 11D illustrate various structures of an second housing part according to various embodiments of the disclosure;

FIGS. 12A and 12B illustrate an example of a screen for guiding a relative location of a satellite for satellite communication according to various embodiments of the disclosure;

FIG. 13A illustrates an unfolding state of an electronic device according to an embodiment of the disclosure;

FIG. 13B illustrates intermediate states and a folding state of an electronic device according to an embodiment of the disclosure;

FIG. 14A illustrates states of an electronic device including a foldable housing according to an embodiment of the disclosure;

FIG. 14B is a graph representing a radiation pattern of an antenna to a state of an electronic device according to an embodiment of the disclosure;

FIG. 14C illustrates an example of a screen for guiding a folding angle by an electronic device according to an embodiment of the disclosure;

FIG. 15 illustrates electronic devices having a deformable structure according to an embodiment of the disclosure;

FIG. 16A illustrates states of an electronic device according to an embodiment of the disclosure; and

FIG. 16B illustrates a rear surface of an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

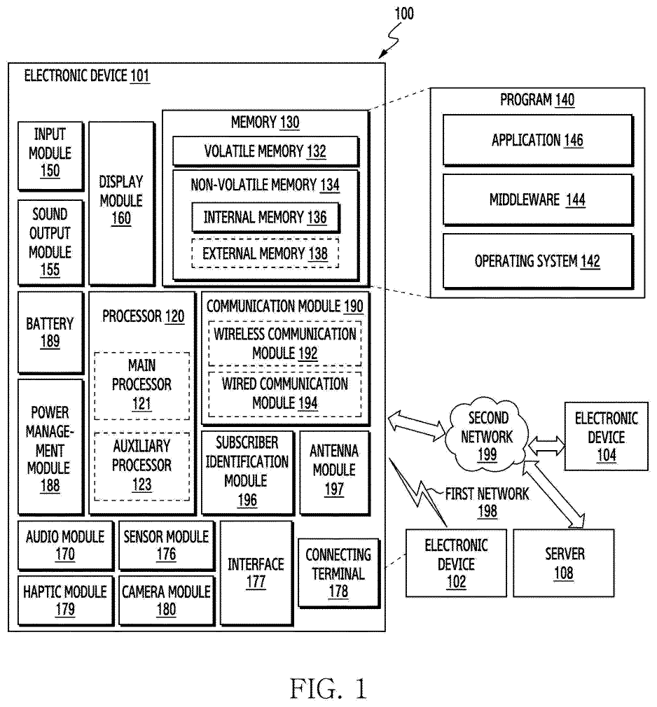

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mm Wave antenna module. According to an embodiment, the mm Wave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on fifth generation (5G) communication technology or IoT-related technology.

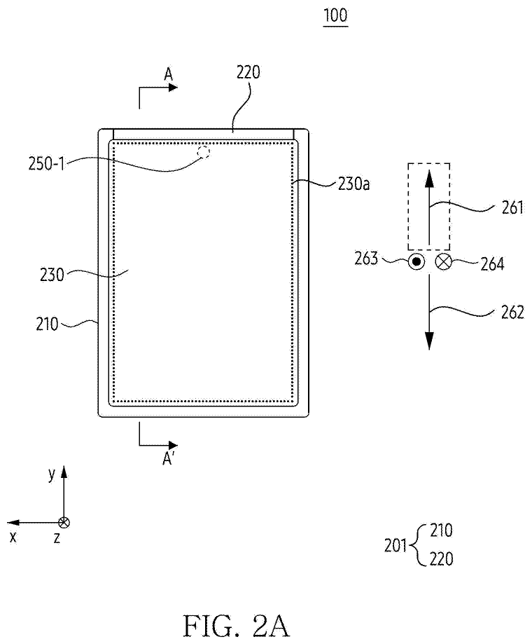

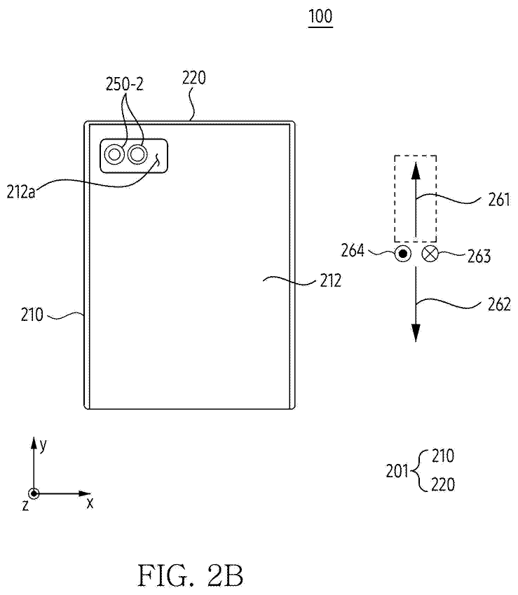

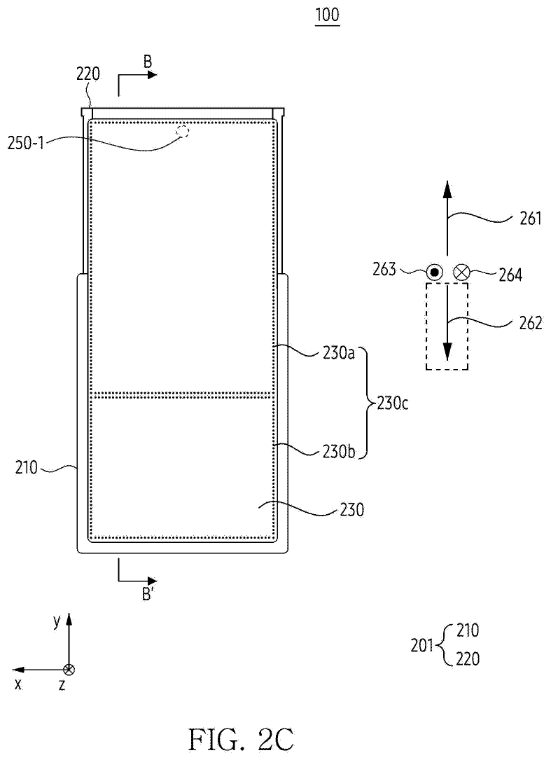

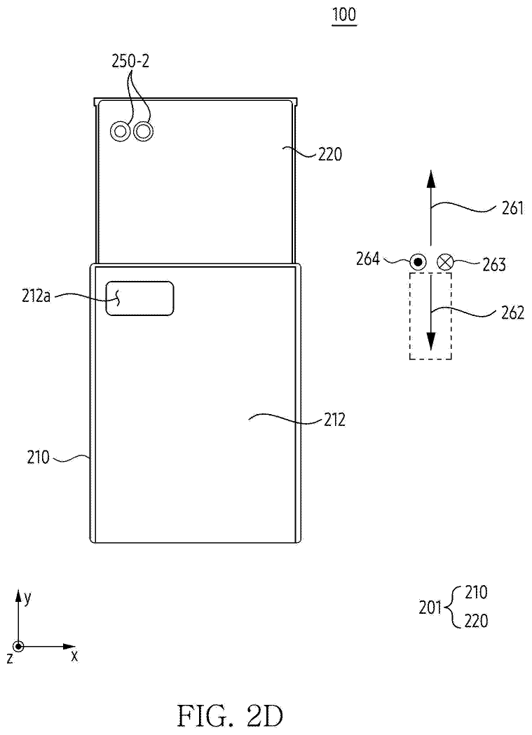

For example, a display of the display module 160 may be flexible. For example, the display may include a display region exposed outside a housing of the electronic device 101 providing at least a portion of an exterior of the electronic device 101. For example, since the display has flexibility, at least a portion of the display may be rollable into the housing or slidable into the housing. For example, a size of the display region may be changed according to a size of the at least a portion of the display rolled into the housing or slid into the housing. For example, the electronic device 101 including the display may be in a plurality of states including a first state providing the display region having a first size and a second state providing the display region having a second size different from the first size. For example, the first state may be exemplified through description of FIGS. 2A and 2B.

FIG. 2A is a top plan view of an electronic device in a first state according to an embodiment of the disclosure.

Referring to FIG. 2A, the electronic device 101 may include a slidable housing 201 and a flexible display 230. For example, the slidable housing 201 may include a first housing part 210 and a second housing part 220. For example, the first housing part 210 may be movable with respect to the second housing part 220 in a first direction 261 parallel to a y-axis or a second direction 262 parallel to the y-axis and opposite to the first direction 261. In the disclosure, it is described that the first housing part 210 moves with respect to the second housing part 220, but the disclosure is not limited thereto. For example, the slidable housing 201 may have a structure in which an overall size of the slidable housing 201 may be changed according to a change in a relative positional relationship between the first housing part 210 and the second housing part 220. For example, the relative positional relationship between the first housing part 210 and the second housing part 220 may be changed by an operation of a motor 361 to be described later. For example, by the motor 361, the second housing part 220 may be movable with respect to the first housing part 210, or both the first housing part 210 and the second housing part 220 may be movable.

For example, the electronic device 101 may be in the first state. For example, in the first state, the second housing part 220 may be movable with respect to the first housing part 210 in the first direction 261 among the first direction 261 and the second direction 262. For example, in the first state, the second housing part 220 may not be substantially movable in the second direction 262 with respect to the first housing part 210.

For example, in the first state, the flexible display 230 may provide the display region having a smallest size. For example, in the first state, the display region may correspond to a first display region 230a. For example, although not illustrated in FIG. 2A, in the first state, a second display region (e.g., the second display region 230b of FIG. 2C) of the flexible display 230 different from the first display region 230a which is the display region may be included in the first housing part 210. For example, in the first state, the region (e.g., the second display region 230b of FIG. 2C) may be covered by the first housing part 210. For example, in the first state, the region may be rollable into the first housing part 210. For example, in the first state, the first display region 230a may include a planar portion. However, it is not limited thereto. For example, the first display region 230a may include, in the first state, a curved portion extending from the planar portion and located within an edge portion.

For example, the first state may be referred to as a slide-in state or a closed state in terms of at least a portion of the second housing part 220 being located in the first housing part 210. For example, the first state may be referred to as a reduced state in terms of the display region having a smallest size being provided. However, it is not limited thereto.

For example, the second housing part 220 may include a first image sensor 250-1 in the camera module 180 exposed through a portion of the first display region 230a and facing a third direction 263 parallel to a z-axis. For example, although not illustrated in FIG. 2A, the second housing part 220 may include one or more second image sensors in the camera module 180 exposed through a portion of the second housing part 220 and facing a fourth direction 264 parallel to the z-axis and opposite to the third direction 263. For example, the one or more second image sensors may be exemplified through description of FIG. 2B.

FIG. 2B is a bottom view of the electronic device in the first state according to an embodiment of the disclosure.

Referring to FIG. 2B, in the first state, one or more second image sensors 250-2 disposed in the second housing part 220 may be located within a structure disposed in the first housing part 210 for the one or more second image sensors 250-2. For example, light from outside of the electronic device 101 may be received by the one or more second image sensors 250-2 through the structure in the first state. For example, since the one or more second image sensors 250-2 are located within the structure in the first state, the one or more second image sensors 250-2 may be exposed through the structure in the first state. For example, the structure may be implemented in various ways. For example, the structure may be an opening or a notch. For example, the structure may be an opening 212a in a first plate 212 of the first housing part 210 surrounding at least a portion of the second housing part 220. However, it is not limited thereto. For example, in the first state, the one or more second image sensors 250-2 included in the second housing part 220 may be covered by the first plate 212 of the first housing part 210.

For example, the first state may be changed to the second state.

For example, the first state (or the second state) may be changed to the second state (or the first state) through intermediate states between the first state and the second state.

For example, the first state (or the second state) may be changed to the second state (or the first state) based on a user input. For example, the first state (or the second state) may be changed to the second state (or the first state), in response to a user input for a physical button exposed through a portion of the first housing part 210 or a portion of the second housing part 220. For example, the first state (or the second state) may be changed to the second state (or the first state), in response to a touch input for an executable object displayed in the display region. For example, the first state (or the second state) may be changed to the second state (or the first state), in response to a touch input having a contact point on the display region and having a pressing intensity greater than or equal to a threshold intensity. For example, the first state (or the second state) may be changed to the second state (or the first state), in response to a voice input received through a microphone of the electronic device 101. For example, the first state (or the second state) may be changed to the second state (or the first state), in response to a force applied to the first housing part 210 and/or the second housing part 220 to move the second housing part 220 with respect to the first housing part 210. For example, the first state (or the second state) may be changed to the second state (or the first state), in response to a user input identified in an external electronic device (e.g., earbuds or smart watch) connected to the electronic device 101. However, it is not limited thereto.

The second state may be exemplified through the description of FIGS. 2C and 2D.

FIG. 2C is a top plan view of an electronic device in a second state according to an embodiment of the disclosure.

Referring to FIG. 2C, the electronic device 101 may be in the second state. For example, in the second state, the second housing part 220 may be movable with respect to the first housing part 210 in the second direction 262 among the first direction 261 and the second direction 262. For example, in the second state, the second housing part 220 may not be substantially movable in the first direction 261 with respect to the first housing part 210.

For example, in the second state, the flexible display 230 may provide the display region having a largest size. For example, in the second state, the display region may correspond to a region 230c including the first display region 230a and the second display region 230b. For example, the second display region 230b which was included in the first housing part 210 in the first state may be exposed in the second state. For example, in the second state, the first display region 230a may include a planar portion. However, it is not limited thereto. For example, the second display region 230b may include a curved portion extending from the planar portion and located within an edge portion. For example, in the second state, the second display region 230b may include a planar portion among the planar portion and the curved portion, unlike the first display region 230a in the first state. However, it is not limited thereto. For example, the second display region 230b may include a curved portion extending from the planar portion of the second display region 230b and located within an edge portion.

For example, the second state may be referred to as a slide-out state or an open state in terms of at least a portion of the second housing part 220 disposed outside the first housing part 210 being extended with respect to the first state. For example, the second state may be referred to as an expanded state in terms of the display region having a largest size being provided. However, it is not limited thereto.

For example, when a state of the electronic device 101 is changed from the first state to the second state, the first image sensor 250-1 facing the third direction 263 may be moved together with the first display region 230a, according to movement of the second housing part 220 in the first direction 261. For example, although not illustrated in FIG. 2C, the one or more second image sensors 250-2 facing the fourth direction 264 may be moved according to movement of the second housing part 220 in the first direction 261 when the state of the electronic device 101 is changed from the first state to the second state. For example, a relative positional relationship between the one or more second image sensors 250-2 and the structure exemplified through description of FIG. 2D may be changed according to the movement of the one or more second image sensors 250-2. For example, the change in the relative positional relationship may be exemplified through FIG. 2D.

FIG. 2D is a bottom view of the electronic device in the second state according to an embodiment of the disclosure.

Referring to FIG. 2D, in the second state, the one or more second image sensors 250-2 may be located outside the structure. For example, the structure may include an opening 212a. For example, in the second state, the one or more second image sensors 250-2 may be located outside the opening 212a in the first plate 212. For example, the one or more second image sensors 250-2 may be exposed through the opening 212a in the second state. For example, since the one or more second image sensors 250-2 are located outside the first housing part 210 in the second state, the one or more second image sensors 250-2 may be exposed in the second state. For example, since the one or more second image sensors 250-2 are located outside the structure in the second state, the relative positional relationship in the second state may be different from the relative positional relationship in the first state.

For example, when the electronic device 101 does not include the structure such as the opening 212a, the one or more second image sensors 250-2 may be exposed in the second state among the first state and the second state.

Although not illustrated in FIGS. 2A, 2B, 2C, and 2D, the electronic device 101 may be in an intermediate state between the first state and the second state. For example, a size of the display region in the intermediate state may be greater than a size of the display region in the first state and smaller than a size of the display region in the second state. For example, the display region in the intermediate state may correspond to a region including the first display region 230a and a portion of the second display region 230b. For example, in the intermediate state, a portion of the second display region 230b may be exposed, and another portion (or a remaining portion) of the second display region 230b may be covered by the first housing part 210 or rollable into the first housing part 210. However, it is not limited thereto.

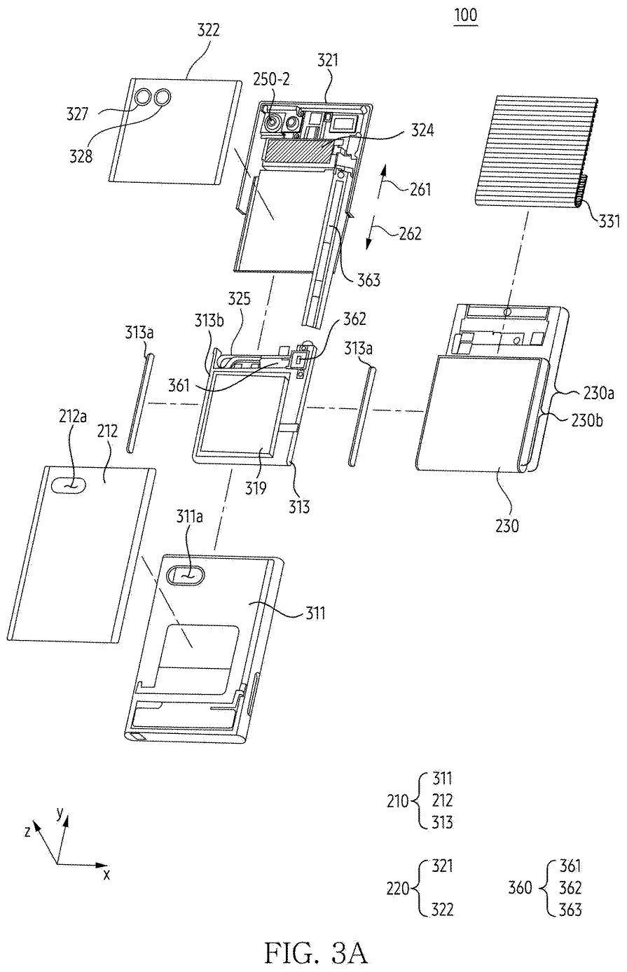

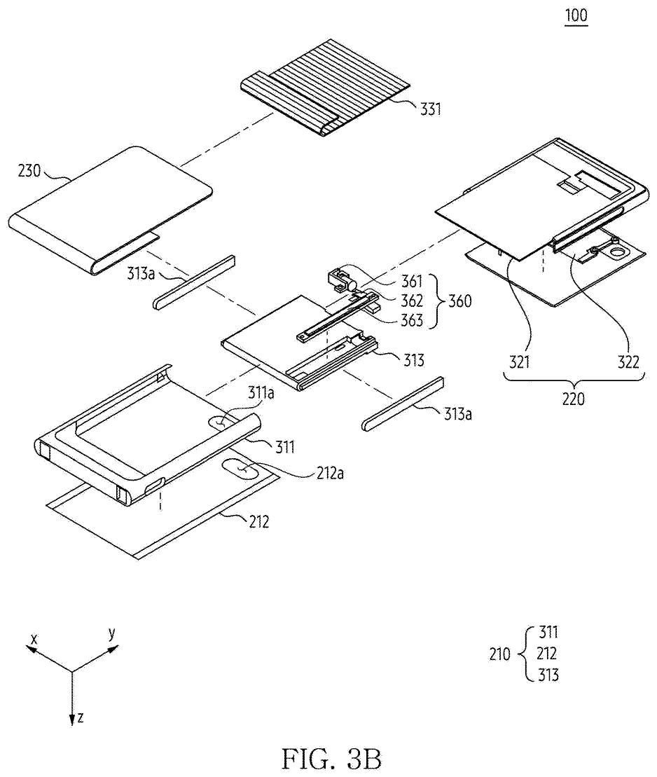

Referring again to FIG. 1, the electronic device 101 may include structures for moving a second housing (e.g., the second housing part 220 of FIG. 2A) of the electronic device 101 with respect to a first housing (e.g., the first housing part 210 of FIG. 2A) of the electronic device 101. For example, the structures may be exemplified through description of FIGS. 3A and 3B.

FIGS. 3A and 3B are exploded perspective views of an electronic device.

Referring to FIGS. 3A and 3B, the electronic device 101 may include a first housing part 210, a second housing part 220, a flexible display 230, and a driving mechanism 360.

For example, the first housing part 210 may include a first cover 311, a first plate 212, and a frame 313.

For example, the first cover 311 may at least partially form a side portion of an exterior of the electronic device 101. For example, the first cover 311 may include an opening 311a for one or more second image sensors 250-2. For example, the first cover 311 may include a surface supporting the first plate 212. For example, the first cover 311 may be coupled with the first plate 212. For example, the first cover 311 may include the frame 313. For example, the first cover 311 may be coupled with the frame 313.

For example, the first plate 212 may at least partially form a rear portion of the exterior. For example, the first plate 212 may include an opening 212a for the one or more second image sensors 250-2. For example, the first plate 212 may be disposed on the surface of the first cover 311. For example, the opening 212a may be aligned with the opening 311a.

For example, the frame 313 may be surrounded at least partially by the first cover 311.

For example, the frame 313 may be surrounded at least partially by the flexible display 230. For example, the frame 313 may be surrounded at least partially by the flexible display 230, but a location of the frame 313 may be maintained independently of movement of the flexible display 230. For example, the frame 313 may be arranged in relation to at least a portion of components of the flexible display 230. For example, the frame 313 may include rails 313a providing (or guiding) a path of movement of at least one component of the flexible display 230.

For example, the frame 313 may be coupled with at least one component of the electronic device 101. For example, the frame 313 may support a battery 189. For example, the battery 189 may be supported through a recess or a hole in a surface 313b of the frame 313. For example, the frame 313 may be coupled with an end of a flexible printed circuit board (FPCB) 325 on a surface on the frame 313. For example, although not explicitly illustrated in FIGS. 3A and 3B, another end of the FPCB 325 may be connected to a PCB 324 through at least one connector. For example, the PCB 324 may be electrically connected to another PCB (not illustrated in FIGS. 3A and 3B) supplying power to the motor 361, through the FPCB 325.

For example, the frame 313 may be coupled with at least one structure of the electronic device 101 for a plurality of states including the first state and the second state. For example, the frame 313 may fasten a motor 361 of a driving mechanism 360.

For example, the second housing part 220 may include a second cover 321 and a second plate 322.

For example, the second cover 321 may be surrounded at least partially by the flexible display 230. For example, the second cover 321 may be coupled with at least a portion of the first display region 230a of the flexible display 230 surrounding the second cover 321.

For example, the second cover 321 may be coupled with at least one component of the electronic device 101. For example, the second cover 321 may be coupled with a printed circuit board (PCB) 324 including components of the electronic device 101. For example, the PCB 324 may include a processor 120 (not illustrated in FIGS. 3A and 3B). For example, the second cover 321 may support one or more second image sensors 250-2.

For example, the second cover 321 may be coupled with the second plate 322.

For example, the second plate 322 may be coupled with the second cover 321 to protect at least one component of the electronic device 101 coupled in the second cover 321 and/or at least one structure of the electronic device 101 coupled in the second cover 321. For example, the second plate 322 may include a structure for the at least one component. For example, the second plate 322 may include one or more openings 326 for the one or more second image sensors 250-2. For example, the one or more openings 326 may be aligned with the one or more second image sensors 250-2 disposed on the second cover 321. For example, a size of each of the one or more openings 326 may correspond to a size of each of lenses included in the one or more second image sensors 250-2.

For example, the electronic device 101 may include a support member 331 for supporting at least a portion of the flexible display 230. For example, the support member 331 may include a plurality of bars. For example, the plurality of bars may be coupled with each other. The support member 331 may support the second display region 230b of the flexible display 230.

For example, the driving mechanism 360 may be configured to provide a first state of the electronic device 101, a second state of the electronic device 101, and a third state of the electronic device 101 between the first state and the second state. The driving mechanism 360 may include a motor 361, a pinion gear 362, and a rack gear 363.

For example, the motor 361 may operate based on power from the battery 189. For example, the power may be provided to the motor 361 in response to the user input.

For example, the pinion gear 362 may be coupled with the motor 361 through a shaft. For example, the pinion gear 362 may be rotated based on the operation of the motor 361 transmitted through the shaft.

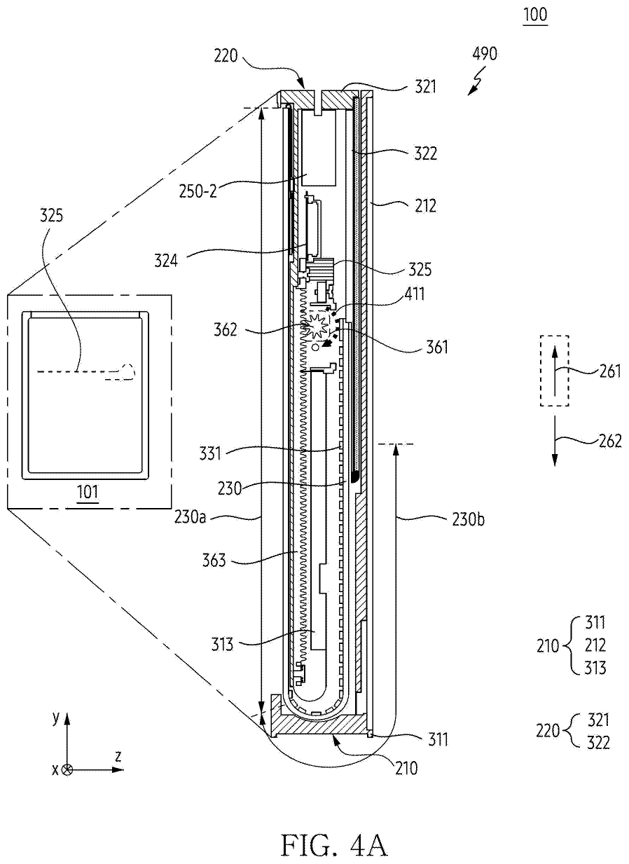

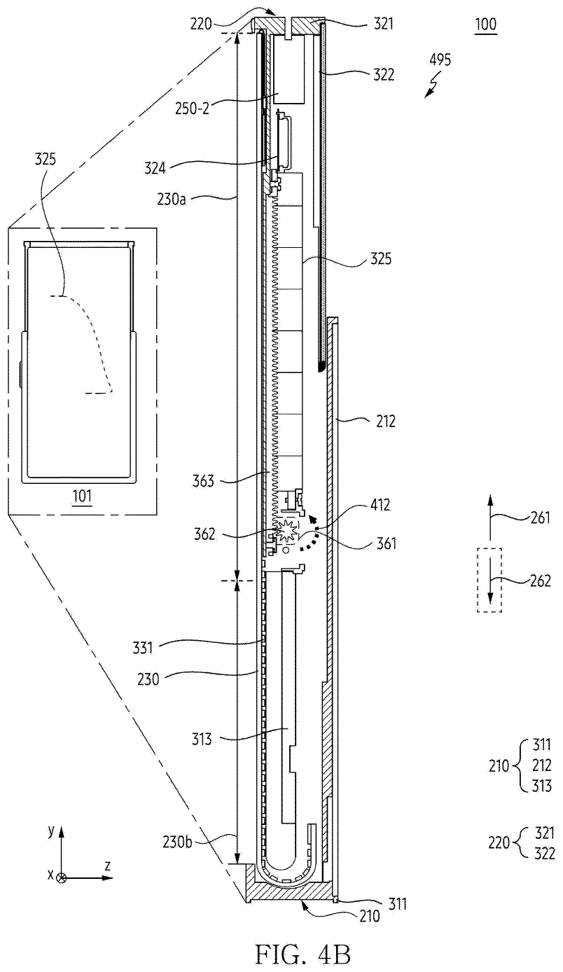

For example, the rack gear 363 may be arranged in relation to the pinion gear 362. For example, teeth of the rack gear 363 may be engaged with teeth of the pinion gear 362. For example, the rack gear 363 may be moved in the first direction 261 or the second direction 262, according to rotation of the pinion gear 362. For example, the rack gear 363 may be coupled with the first housing part 210 or the second housing part 220. For example, the second housing part 220 may be moved in the first direction 261 and the second direction 262 by the rack gear 363 moved according to the rotation of the pinion gear 362 due to the operation of the motor 361. For example, the first state of the electronic device 101 may be changed to a state (e.g., the one or more intermediate states or the second state) different from the first state through the movement of the second housing part 220 in the first direction 261. For example, the second state of the electronic device 101 may be changed to a state (e.g., the one or more intermediate states or the first state) different from the second state through the movement of the second housing part 220 in the second direction 262. For example, the first state being changed to the second state by the driving mechanism 360 and the second state being changed to the first state by the driving mechanism 360 may be exemplified through FIGS. 4A and 4B.

FIG. 4A is a cross-sectional view of an electronic device in a first state according to an embodiment of the disclosure. FIG. 4B is a cross-sectional view of an electronic device in a second state according to an embodiment of the disclosure.

For example, FIG. 4A is a cross-sectional view of an electronic device 101 cut along A-A′ of FIG. 2A. For example, FIG. 4B is a cross-sectional view of an electronic device 101 cut along B-B′ of FIG. 2C.

Referring to FIGS. 4A and 4B, the motor 361 may be operated based at least in part on the defined user input received in a state 490 which is the first state. For example, the pinion gear 362 may be rotated in a first rotation direction 411 based at least in part on the operation of the motor 361. For example, the rack gear 363 may be moved in the first direction 261 based at least in part on the rotation of the pinion gear 362 in the first rotation direction 411. For example, the second housing part 220 may be moved in the first direction 261 based at least in part on the movement of the rack gear 363 in the first direction 261. For example, the second cover 321 in the second housing part 220 may be moved based at least in part on the movement of the rack gear 363 in the first direction 261. For example, the flexible display 230 may be moved along the rails 313a. For example, a shape of at least a portion of the plurality of bars of the support member 331 of the flexible display 230 may be changed when the state 490 which is the first state is changed to a state 495 which is the second state.

For example, the second display region 230b of the flexible display 230 may be moved according to the movement of the flexible display 230. For example, the second display region 230b may be moved through a space between the first cover 311 and the frame 313 when the state 490 is changed to the state 495 according to the defined user input. For example, the second display region 230b in the state 495 may be exposed, unlike the second display region 230b rolled into the space in the state 490.

For example, since the second cover 321 in the second housing part 220 is coupled with the PCB 324 connected with the another end of the FPCB 325 and fixes the rack gear 363, a shape of the FPCB 325 may be changed when the state 490 is changed to the state 495.

The motor 361 may be operated based at least in part on the defined user input received in the state 495. For example, the pinion gear 362 may be rotated in a second rotation direction 412 based at least in part on the operation of the motor 361. For example, the rack gear 363 may be moved in the second direction 262 based at least in part on the rotation of the pinion gear 362 in the second rotation direction 412. For example, the second housing part 220 may be moved in the second direction 262 based at least in part on the movement of the rack gear 363 in the second direction 262. For example, the flexible display 230 may be moved based at least in part on the movement of the rack gear 363 in the second direction 262. For example, the flexible display 230 may be moved along the rails 313a. For example, a shape of at least a portion of the plurality of bars of the support member 331 of the flexible display 230 may be changed when the state 495 is changed to the state 490. The support member 331 may be moved with respect to the first housing part 210. The support member 331 accommodated inside the first housing part 210 in the state 490 may be located between the first cover 311 and the frame 313. The flexible display 230 may be moved with respect to the first housing part 210 according to movement of the support member 331.

For example, the second display region 230b of the flexible display 230 may be moved according to the movement of the flexible display 230. For example, the second display region 230b may be moved through a space between the first cover 311 and the frame 313 when the state 495 is changed to the state 490 according to the defined user input. For example, the second display region 230b in the state 490 may be rollable into the space, unlike the second display region 230b exposed in the state 495.

For example, since the second cover 321 of the second housing part 220 is coupled with the PCB 324 connected with the another end of the FPCB 325 and fixes the rack gear 363, a shape of the FPCB 325 may be changed when the state 495 is changed to the state 490.

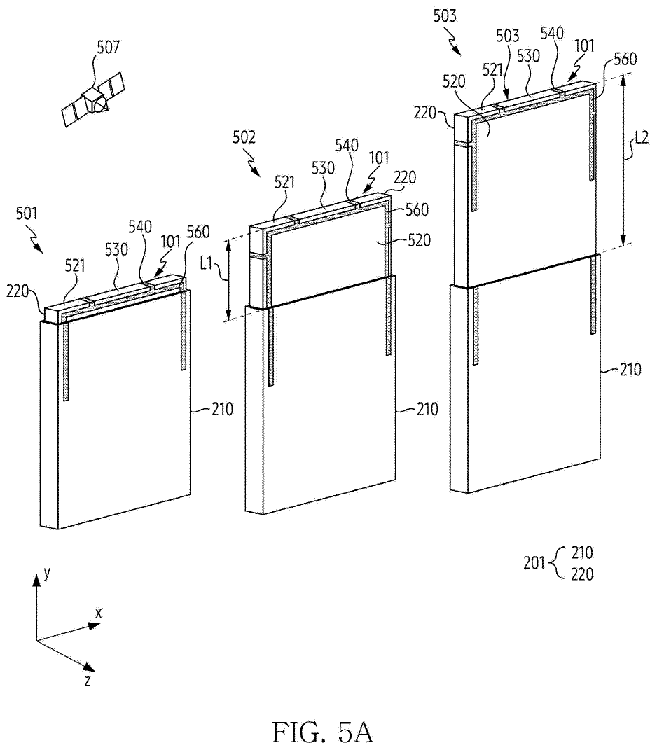

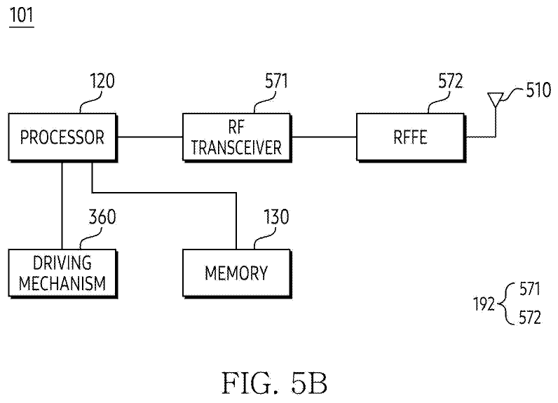

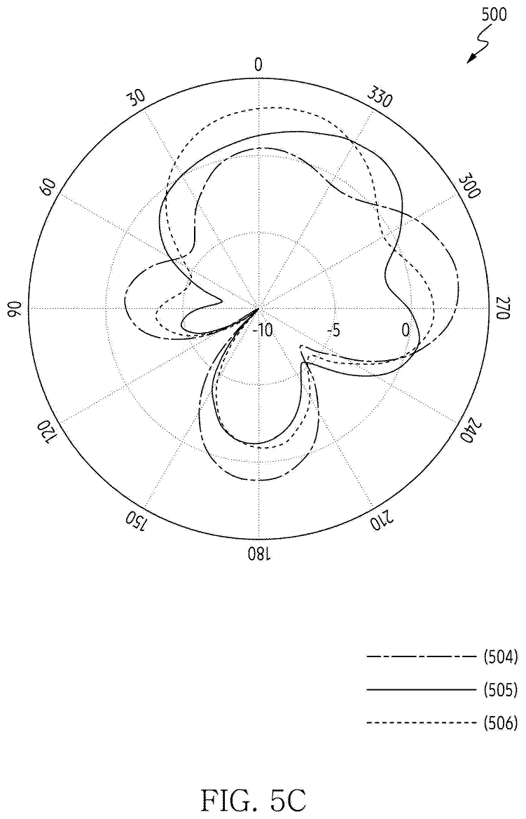

An electronic device 101 may be configured to wirelessly communicate with an external electronic device. For example, the external electronic device may include a satellite (e.g., the satellite 507 of FIG. 5A). Since an orbit of the satellite 507 is located several hundreds of kilometers to several tens of thousands of kilometers above the ground on which the electronic device 101 is located, a relative location of the satellite 507 with respect to the electronic device 101 may be upward. In the disclosure, terms indicating a relative location such as “upward,” “upper,” and “top” may be used to indicate a direction in which the electronic device 101 faces the satellite 507.

For example, when a user carries the electronic device 101 to use the electronic device 101, a relative location of the satellite 507 with respect to the electronic device 101 may be upward of the electronic device 101. For example, an upper end of the electronic device 101 may indicate a periphery of the electronic device 101 located in a direction toward the satellite 507. For example, an upper portion or an upper hemisphere of the electronic device 101 may indicate a region located in an upper portion (e.g., +y direction) with respect to a virtual line passing through a center of a long periphery of the electronic device 101. For example, while the electronic device 101 receives a signal from the satellite 507 or transmits a signal to the satellite 507, when a radiation pattern of an antenna transmitting and/or receiving the signal has high upward directivity, upper hemisphere isotropic sensitivity (UHIS) performance of the electronic device 101 may be improved. For example, when upward directivity of the radiation pattern of the antenna is high, satellite communication efficiency of the electronic device 101 may be improved by improvement of UHIS performance of the electronic device 101. In the disclosure, “a state in which upward directivity is high” may be referred to as a state in which the radiation pattern of the antenna has high upward directivity. For example, a state in which upward directivity of the radiation pattern of the antenna is high may be referred to as a state in which the radiation pattern of the antenna faces upward toward the satellite 507.

An electronic device 101 may be configured to perform satellite communication in a state in which the radiation pattern of the antenna has high upward directivity to improve satellite communication efficiency. Hereinafter, descriptions of the structure are described with reference to the drawings.

Hereinafter, one or more components to be described later with reference to the drawings may be implemented together with components of the electronic device 101 described with reference to FIGS. 1, 2A to 2D, 3A, 3B, 4A, and 4B. The same reference numerals are assigned to the same components as the above-described components, and redundant descriptions may be omitted.

In the disclosure, relative terms such as front and rear are described based on a direction illustrated in the drawings for convenience of description and are not intended as absolute terms. For example, front and rear are used as terms for indicating surfaces opposite to each other and are not limited to absolute directions.

FIG. 5A illustrates an electronic device in which a display is omitted according to an embodiment of the disclosure. FIG. 5B is a block diagram of an electronic device according to an embodiment of the disclosure. FIG. 5C is a graph representing a radiation pattern of an antenna to a state of an electronic device according to an embodiment of the disclosure.

Referring to FIG. 5A, an electronic device 101 may include a slidable housing 201 including a first housing part 210 and a second housing part 220. Although not illustrated in FIG. 5A, the electronic device 101 may include a driving mechanism (e.g., the driving mechanism 360 of FIG. 3A) for driving the second housing part 220. For example, the driving mechanism 360 may include a motor (e.g., the motor 361 of FIG. 3A), a pinion gear (e.g., the pinion gear 362 of FIG. 3A), and a rack gear (e.g., the rack gear 363 of FIG. 3A).

For example, the slidable housing 201 may be deformable by the first housing part 210 and the second housing part 220 movably coupled with each other. For example, the second housing part 220 may be slidably coupled to the first housing part 210. For example, a state 501 of FIG. 5A illustrates the electronic device 101 in a first state in which the second housing part 220 is inserted into an inside of the first housing part 210 as much as possible. For example, a state 503 of FIG. 5A illustrates the electronic device 101 in a second state in which the second housing part 220 is slid out to an outside of the first housing part 210 as much as possible. A state 502 of FIG. 5A illustrates the electronic device 101 in a third state between the first state and the second state. For example, the third state may include a plurality of intermediate states between the first state and the second state.

In the disclosure, a size and a length of the slidable housing 201 may be referred to as a size and a length of the slidable housing 201 in a state in which the first housing part 210 and the second housing part 220 are coupled, rather than a size and a length of each of the first housing part 210 and the second housing part 220, which are separated.

For example, in the first state, a size of the second housing part 220 inserted into the first housing part 210 may be maximum. In the first state in which a size of the second housing part 220 inserted into the first housing part 210 is maximum, a size of the slidable housing 201 may be minimum. For example, in the second state, a size of the second housing part 220 inserted into the first housing part 210 may be minimum. In the second state in which a size of the second housing part 220 inserted into the first housing part 210 is minimum, a size of the slidable housing 201 may be maximum. For example, in the third state, a size of the second housing part 220 inserted into the first housing part 210 may be smaller than a size of the second housing part 220 in the first state and greater than a size of the second housing part 220 in the second state. In the third state, a size of the slidable housing 201 may be greater than a size of the slidable housing 201 in the first state and smaller than a size of the slidable housing 201 in the second state.

For example, the driving mechanism 360 may be configured to provide a driving force for sliding movement of the second housing part 220 with respect to the first housing part 210. For example, the driving mechanism 360 may enable sliding movement of the second housing part 220 with respect to the first housing part 210. For example, the driving mechanism 360 may be configured to provide the first state, the second state, and the third state of the slidable housing 201 by causing sliding of the second housing part 220.

For example, the driving mechanism 360 may move the second housing part 220 such that the second housing part 220 is slid out with respect to the first housing part 210 in a first direction (e.g., +y direction). For example, the driving mechanism 360 may move the second housing part 220 such that the second housing part 220 is slid in with respect to the first housing part 210 in a second direction (e.g., −y direction). For example, the second state and the third state may be distinguished according to a slide-out length of the second housing part 220, based on a relative location of the second housing part 220 with respect to the first housing part 210 in the first state. For example, based on a location of the second housing part 220 in the first state, in the second state in which the slide-out length of the second housing part 220 is maximum, a slide-out length L2 of the second housing part 220 may be about 65 mm. For example, based on the location of the second housing part 220 in the first state, in the third state, the slide-out length of the second housing part 220 may be greater than 0 mm and smaller than about 65 mm. For example, at 502 of FIG. 5A, a slide-out length L1 of the second housing part 220 may be about 30 mm, but it is not limited thereto.

Referring to FIG. 5B, an electronic device 101 may include at least one processor 120, wireless communication circuitry (e.g., the wireless communication module 192 of FIG. 1), an antenna 510, and/or memory 130.

For example, the at least one processor 120 may include processing circuitry. The at least one processor 120 may include an application processor (AP) (e.g., central processing unit (CPU)), a communication processor (CP) (e.g., a modem), a graphics processing unit (e.g., GPU), a neural processing unit (NPU) (e.g., an AI chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display driver integrated circuit (DDI), an audio CODEC chip, a universal serial bus (USB) controller, a camera controller, an image processing IC, a microprocessor unit (MPU), a system on chip (SoC), an IC, or a circuit similar thereto.

For example, the wireless communication circuitry 192 may include a radio frequency (RF) transceiver 571 and a radio frequency front end (RFFE) 572.

For example, the at least one processor 120 may generate a baseband signal. The at least one processor 120 may control the RF transceiver 571 to process the generated baseband signal. The at least one processor 120 may control the RF transceiver 571 such that a transmission signal is transmitted through the antenna 510. The at least one processor 120 may control the RF transceiver 571 such that the transmission signal is transmitted in a frequency band capable of communicating with an external electronic device.

For example, the RF transceiver 571 may be implemented as a single chip (e.g., RFIC chip) or as a part of a single package. The RF transceiver 571 may include a digital to analog converter (DAC) for converting a digital signal into an analog signal. The RF transceiver 571 may include a mixer and an oscillator (e.g., a local oscillator (LO)) for up-conversion. The RF transceiver 571 may convert the baseband signal generated by the at least one processor 120 into an RF signal. The RF transceiver 571 may include an analog to digital converter (ADC) for converting an analog signal into a digital signal. The RF transceiver 571 may include a mixer and an oscillator for down-conversion. The RF transceiver 571 may convert an RF signal received from the antenna 510 into a baseband signal such that it may be processed by the at least one processor 120.

For example, the RFFE 572 may include a plurality of components electrically connected between the RF transceiver 571 and the antenna 510. For example, the RFFE 572 may include components such as a coupler, a power amplifier (PA), a low noise amplifier (LNA), a switch circuit, and/or a duplexer, but it is not limited thereto.

For example, the wireless communication circuitry 192 may be configured to communicate with an external electronic device using a signal on a designated frequency band. For example, the antenna 510 may be used to transmit and/or receive a signal on the designated frequency band. For example, the antenna 510 may include a feeding point to which a feeding signal provided from the RF transceiver 571 is provided and a ground point electrically connected with a ground of the electronic device 101. For example, the antenna 510 may include an antenna radiator, which is a physical configuration for radiating or receiving electromagnetic waves. The antenna radiator is a physical component of the antenna 510 for radiating or receiving electromagnetic waves, and a shape and a characteristic (e.g., a frequency characteristic of the antenna 510) of the antenna 510 may be determined by the antenna radiator.

For example, the at least one processor 120 may be operably connected with the driving mechanism 360. For example, the at least one processor 120 may be configured to provide, to the driving mechanism 360, a control signal for causing sliding movement of the second housing part 220. For example, the driving mechanism 360 may provide a driving force for sliding movement of the second housing part 220, based on the control signal provided from the at least one processor 120. For example, the second housing part 220 may be slid out from the first housing part 210 or slid in to the first housing part 210, by the driving mechanism 360.

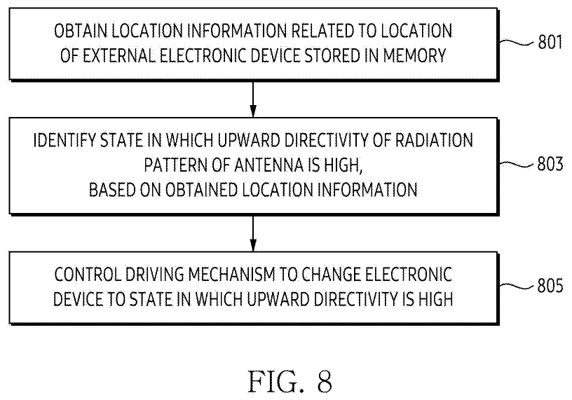

For example, the memory 130 may include one or more storage media storing instructions. For example, the memory 130 may store information about an orbit of the satellite 507 according to time. Since the satellite 507 moves along a designated orbit with respect to the earth, a relative location of the satellite 507 with respect to the electronic device 101 may be changed according to time. The at least one processor 120 may identify a location of the satellite 507 based on the information stored in the memory 130. The at least one processor 120 may identify a location of the satellite 507 at a time point at which satellite communication is performed based on the information about the orbit of the satellite 507 stored in the memory 130. The instructions, when executed by the at least one processor 120, may cause the electronic device 101 to change to a state in which upward directivity of a radiation pattern of the antenna 510 is high. For example, the instructions, when executed by the at least one processor 120, may cause the electronic device 101 to perform operations described or illustrated in FIGS. 8, 9B, 9C, 10, 12A, 12B, and/or 14C.

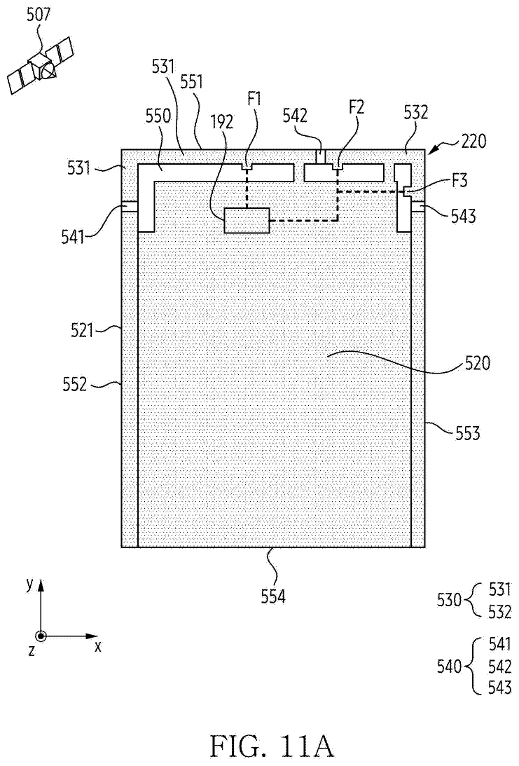

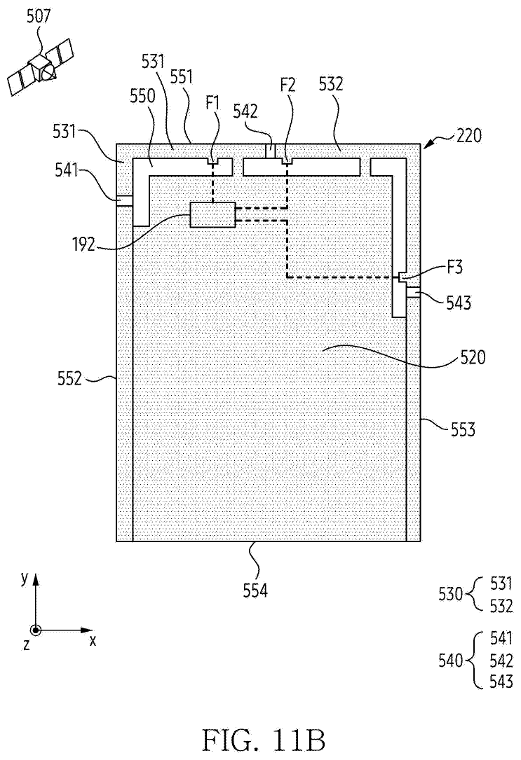

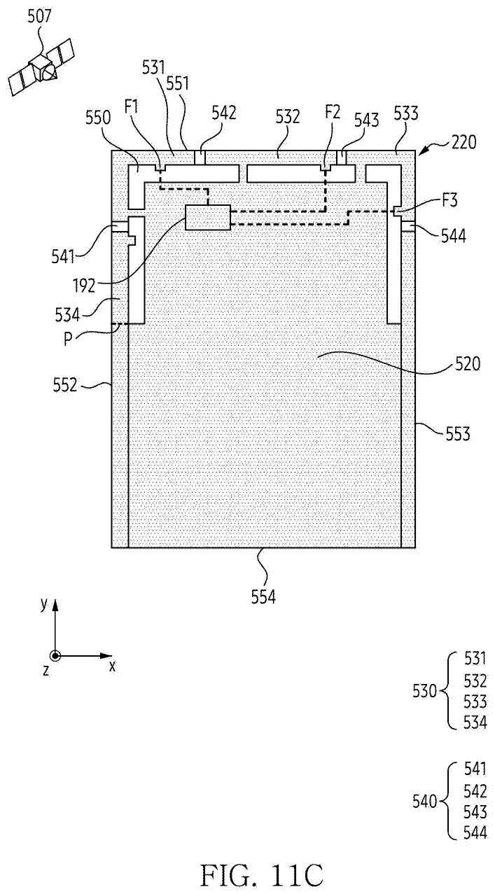

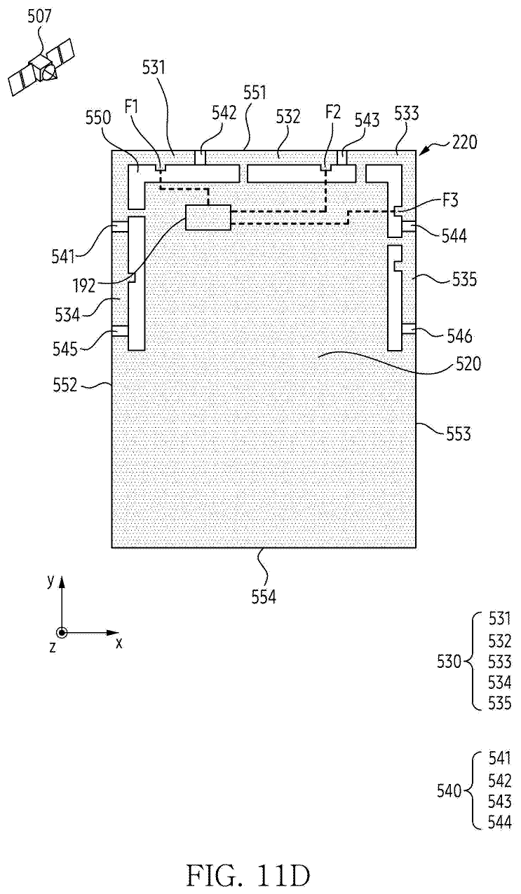

Referring again to FIG. 5A, the second housing part 220 may include a support member 520 and a side frame 521. For example, the support member 520 may support components (e.g., a printed circuit board, a camera) disposed in the second housing part 220. For example, the side frame 521 may form at least a portion of a side of the second housing part 220. For example, the side frame 521 may surround at least a portion of a periphery of the support member 520. For example, a slot 560 in which a plurality of opening regions (e.g., the plurality of opening regions 550 of FIG. 11A) or at least a portion of the plurality of opening regions 550 is filled with a non-conductive material may be formed in a partial region between the support member 520 and the side frame 521.

An electronic device 101 may include a plurality of conductive portions 530. For example, the plurality of conductive portions 530 may be formed along at least a portion of a periphery of the second housing part 220. For example, the plurality of conductive portions 530 may be electrically disconnected by a plurality of non-conductive portions 540.

For example, the wireless communication circuitry 192 may be configured to communicate with an external electronic device using at least one of the plurality of conductive portions 530. For example, the wireless communication circuitry 192 may be configured to feed a feeding point of at least one conductive portion among the plurality of conductive portions 530. The at least one conductive portion may be configured to transmit a wireless signal by radiating electromagnetic waves to an outside by being fed by the wireless communication circuitry 192. For example, the at least one conductive portion may operate as an antenna radiator.

For example, the at least one conductive portion used as the antenna radiator may include a ground point electrically connected with a ground of the electronic device 101. For example, the support member 520 may provide the ground of the electronic device 101. For example, the at least one conductive portion may be electrically connected with the support member 520.

For example, in terms of an RF signal, the ground may be referred to as a conductive region of the slidable housing 201 as well as the support member 520. For example, since the first housing part 210 and the second housing part 220 are coupled for sliding movement, in terms of the RF signal, the first housing part 210 and the second housing part 220 may operate as one ground. For example, in terms of the antenna 510 including the at least one conductive portion, the slidable housing 201 may operate as one ground.

For example, since a size of the slidable housing 201 may be different according to the first state, the second state, and the third state, in terms of an RF signal, a size of the ground may be determined based on a state of the electronic device 101. For example, in the first state, the size of the ground may be minimum. For example, in the second state, the size of the ground may be maximum. For example, in the third state, the size of the ground may be greater than the size of the ground in the first state and smaller than the size of the ground in the second state.

For example, a radiation pattern of the antenna 510 including at least one conductive portion may be different according to the size of the slidable housing 201. For example, since the size of the slidable housing 201 operating as the ground with respect to the antenna 510 is different according to the state of the electronic device 101, a radiation pattern of the antenna 510 may be changed by a change of the state of the electronic device 101.

Referring to FIG. 5C, a change in the radiation pattern of the antenna 510 according to the state of the electronic device 101 may be identified.

A graph 500 illustrated in FIG. 5C is a graph representing, on a polar coordinate system, a result of measuring a gain of the antenna 510 including at least one conductive portion among a plurality of conductive portions (e.g., the plurality of conductive portions 530 of FIG. 5A) while rotating an elevation angle with respect to an electronic device 101 (e.g., the electronic device 101 of FIG. 5A) having a posture in which an azimuth angle is fixed. For example, a distance from a pole indicates the gain, and an angle with respect to a polar axis indicates the elevation angle. For example, an angle of 0 degrees indicates a direction toward which an upper portion of the electronic device 101 faces (e.g., +y direction). For example, an angle of 90 degrees indicates a direction toward which a side of the electronic device 101 faces (e.g., −x direction). For example, an angle of 180 degrees indicates a direction toward which a lower portion of the electronic device 101 faces (e.g., −y direction). For example, an angle of 270 degrees indicates a direction toward which another side of the electronic device 101 faces (e.g., +x direction).

The graph 500 of FIG. 5C represents a radiation pattern based on a gain of the antenna 510 with respect to a signal on a designated frequency band (e.g., about 1.6 GHz) according to a change of the elevation angle with respect to the electronic device 101 having the posture in which the azimuth angle is fixed.

A first graph 504 of FIG. 5C represents a radiation pattern of the antenna 510 when the electronic device 101 is in the first state. A second graph 505 of FIG. 5C represents a radiation pattern of the antenna 510 when the electronic device 101 is in the second state. For example, the second state may be referred to as a state in which a slide-out length of the second housing part 220 is about 65 mm. A third graph 506 of FIG. 5C represents a radiation pattern of the antenna 510 when the electronic device 101 is in the third state. For example, the third state may be referred to as a state in which the slide-out length of the second housing part 220 is about 30 mm among a plurality of intermediate states.

Referring to FIG. 5C, a direction and a gain of a main lobe of the radiation pattern may be different according to the slide-out length of the second housing part 220. For example, when the first graph 504, the second graph 505, and the third graph 506 are compared, the main lobe represented by the third graph 506 may be formed toward an upper portion (e.g., +y direction) of the electronic device 101. The third graph 506 may indicate the highest gain with respect to the upper portion of the electronic device 101. The third graph 506 may indicate higher upward directivity than the first graph 504 and the second graph 505.

For example, when the electronic device 101 receives a signal on a satellite frequency band (e.g., about 1.6 GHz) from a satellite (e.g., the satellite 507 of FIG. 5A), a relative location of the satellite 507 with respect to the electronic device 101 may be upward. For example, when the radiation pattern of the antenna 510 has high upward directivity, satellite communication efficiency may be improved. Referring to FIG. 5C, since upward directivity of the radiation pattern of the antenna 510 is highest when the electronic device 101 is in the third state, the electronic device 101 may provide improved communication performance when the electronic device 101 performs satellite communication in the third state. For example, the third state may be referred to as a state in which upward directivity of the radiation pattern of the antenna 510 is high.

An electronic device 101 may be configured to identify a state in which upward directivity of the radiation pattern of the antenna 510 is high and perform satellite communication in the state in which upward directivity is high. For example, the at least one processor 120 may be configured to control the driving mechanism 360 to change the slidable housing 201 to the state in which upward directivity is high. For example, when the third state is the state in which upward directivity is high, the at least one processor 120 may control the driving mechanism 360 such that the electronic device 101 performs satellite communication in the third state. For example, when the electronic device 101 is in the first state, the at least one processor 120 may control the driving mechanism 360 such that the second housing part 220 is slid out by a length corresponding to the third state. For example, when the electronic device 101 is in the second state, the at least one processor 120 may control the driving mechanism 360 such that the second housing part 220 is slid in by a length corresponding to the third state.

Hereinafter, the state in which upward directivity is high is described.

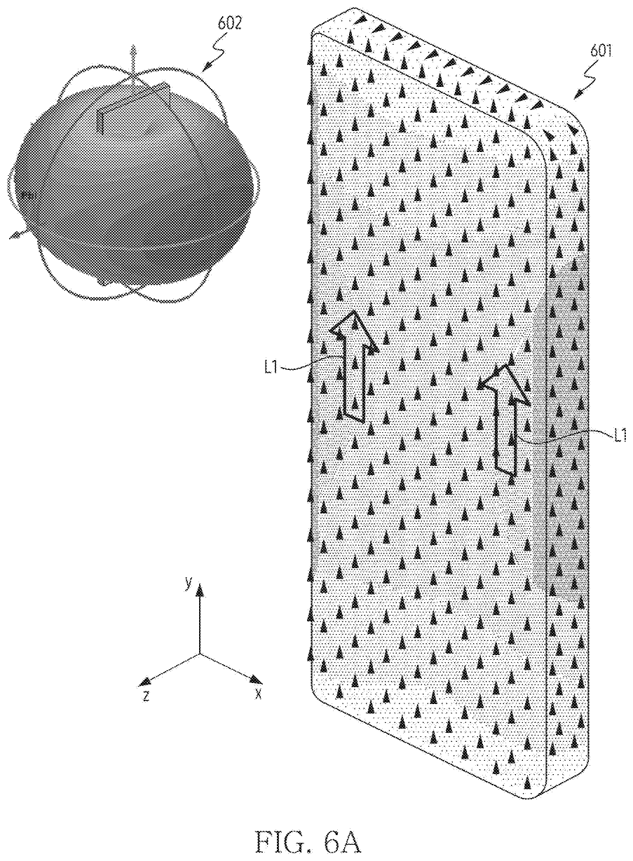

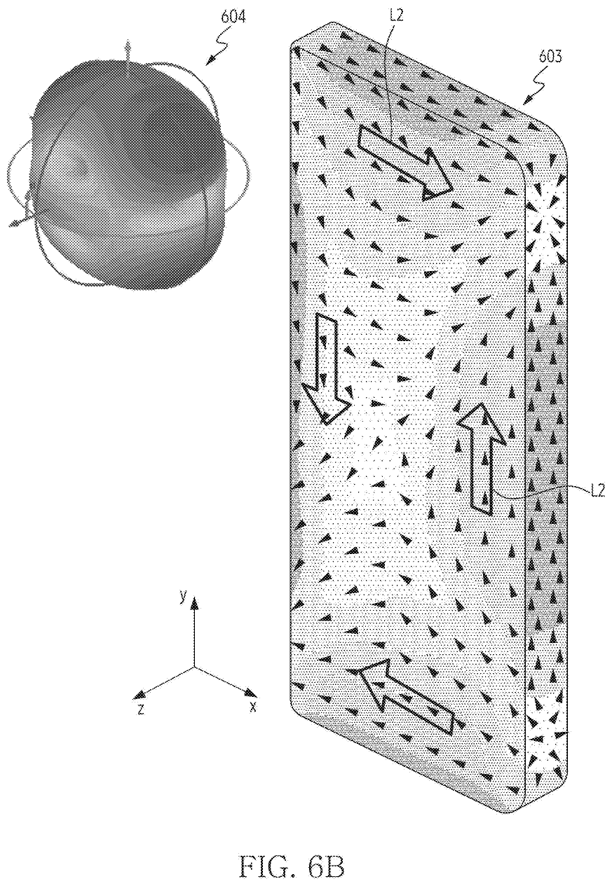

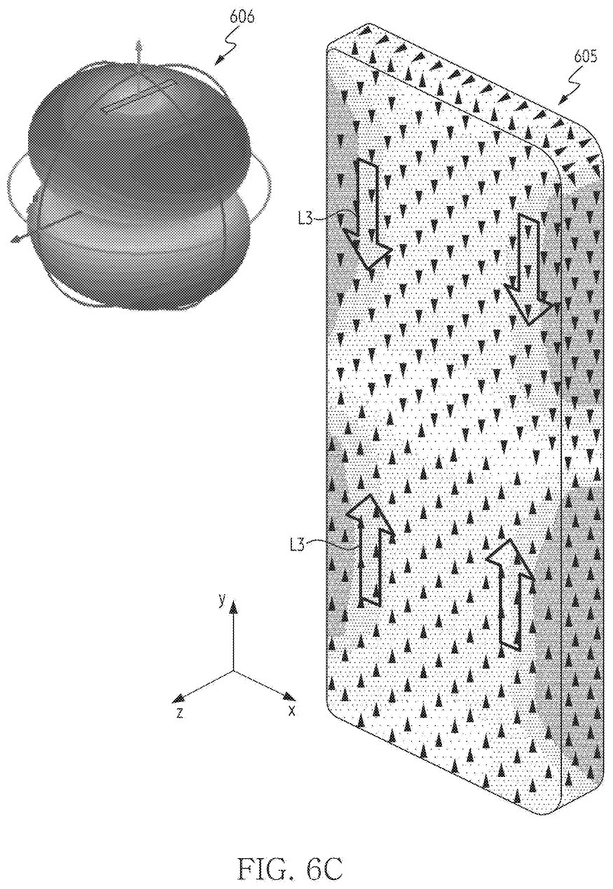

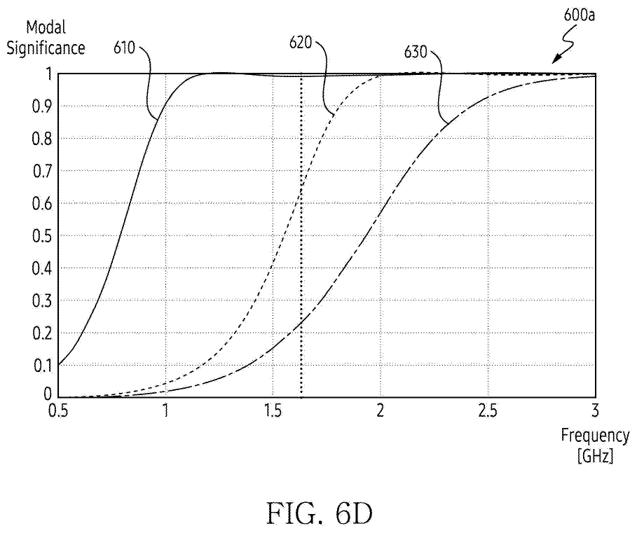

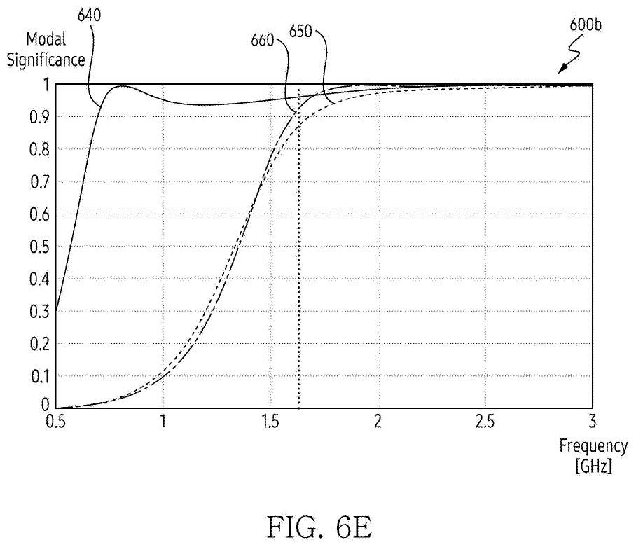

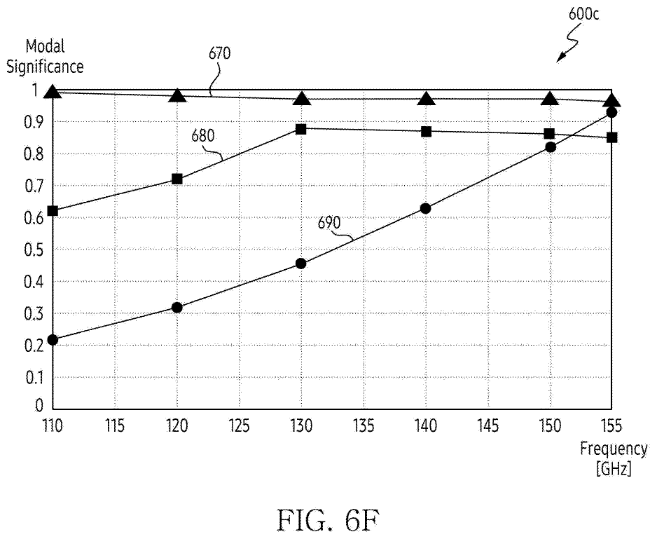

FIGS. 6A, 6B, and 6C schematically illustrate a flow of a current and an electromagnetic field formed in an electronic device according to various embodiments of the disclosure. FIGS. 6D and 6E are graphs representing modal significance of a plurality of modes according to a frequency with respect to a slidable housing having a certain length according to various embodiments of the disclosure. FIG. 6F is a graph representing modal significance of a plurality of modes according to a slidable housing with respect to a designated frequency according to an embodiment of the disclosure.

FIGS. 6A, 6B, and 6C represent a plurality of modes that may be formed in a structure of an electronic device (e.g., the electronic device 101 of FIG. 5A). For example, the plurality of modes may be referred to as distribution patterns of an electromagnetic field determined by a structure of the electronic device 101. For example, the plurality of modes may be identified through characteristic mode analysis for analyzing characteristics of a structure. For example, FIGS. 6A, 6B, and 6C may represent a flow of a current and a pattern of an electromagnetic field with respect to a conductive structure corresponding to a structure of a slidable housing (e.g., the slidable housing 201 of FIG. 5A) of the electronic device 101. The flow of the current and the pattern of the electromagnetic field may be interpreted as substantially the same as those formed in the electronic device 101. A first mode, a second mode, and a third mode to be described later may be formed based on a size (e.g., a length) of the conductive structure. For example, when the size of the conductive structure is changed, a mode to be activated may be changed, so the flow of the current is changed. The change of the flow of the current may cause a change of a radiation pattern. Through modes to be described later, a mode capable of reinforcing a radiation pattern with respect to a specific frequency band and/or a specific direction may be identified according to a size (e.g., a length of ground) of the electronic device 101.

For example, an image 601 of FIG. 6A illustrates a flow of a current formed in a structure corresponding to the structure of the electronic device 101 in the first mode. An image 602 of FIG. 6A illustrates a distribution pattern of an electromagnetic field formed in a structure corresponding to the structure of the electronic device 101 in the first mode. An image 603 of FIG. 6B illustrates a flow of a current formed in a structure corresponding to the structure of the electronic device 101 in a second mode. An image 604 of FIG. 6B illustrates a distribution pattern of an electromagnetic field formed in a structure corresponding to the structure of the electronic device 101 in the second mode. An image 605 of FIG. 6C illustrates a flow of a current formed in a structure corresponding to the structure of the electronic device 101 in a third mode. An image 606 of FIG. 6C illustrates a distribution pattern of an electromagnetic field formed in a structure corresponding to the structure of the electronic device 101 in the third mode.

Referring to FIGS. 6A, 6B, and 6C, in the first mode, the second mode, and the third mode, the flow of the current formed in the electronic device 101 may be different. For example, referring to the image 601 of FIG. 6A, in the first mode, the flow of the current may be concentrated on a side (e.g., +x direction and −x direction) of the electronic device 101. In the first mode, a dominant flow L1 of the current may be formed along a direction substantially parallel to the y-axis.

Referring to the image 602 of FIG. 6A, in the first mode, a distribution pattern of an electromagnetic field may be strongly formed on a side of the electronic device 101 on which a current is concentrated. In the first mode, since the current is relatively not concentrated on an upper portion (e.g., +y direction) of the electronic device 101, the distribution pattern of the electromagnetic field may be weakly formed on the upper portion of the electronic device 101.

For example, referring to the image 603 of FIG. 6B, in the second mode, a flow of the current may be concentrated on an upper portion (e.g., +y direction) and a lower portion (e.g., −y direction) of the electronic device 101. In the second mode, a dominant flow L2 of the current may be formed along a direction substantially parallel to the x-axis.

Referring to the image 604 of FIG. 6B, in the second mode, the distribution pattern of the electromagnetic field may be strongly formed on the upper portion and the lower portion of the electronic device 101 on which the current is concentrated. In the second mode, since the current is relatively concentrated on the upper portion of the electronic device 101, the distribution pattern of the electromagnetic field may be strongly formed on the upper portion of the electronic device 101.

For example, referring to the image 605 of FIG. 6C, in the third mode, the flow of the current may be concentrated on a side (e.g., +x direction and −x direction) of the electronic device 101. In the third mode, a dominant flow of the current may be formed toward a center of the electronic device 101, and a flow of the current may be weak at the center of the electronic device 101. A dominant flow L3 of the current may be formed along a direction substantially parallel to the y-axis.

Referring to the image 606 of FIG. 6C, in the third mode, a distribution pattern of an electromagnetic field may be strongly formed on a side of the electronic device 101 on which the current is concentrated and may be weakly formed at a center of the electronic device 101. In the third mode, since the current is relatively not concentrated on an upper portion (e.g., +y direction) of the electronic device 101, the distribution pattern of the electromagnetic field may be weakly formed on the upper portion of the electronic device 101.

Referring to FIG. 6B, when the second mode is formed, upward directivity of a radiation pattern of an antenna (e.g., the antenna 510 of FIG. 5B) may be formed highest. For example, when the electronic device 101 performs satellite communication, satellite communication efficiency may be improved when the electronic device 101 operates in the second mode. In a case of the electronic device 101, a size of a slidable housing (e.g., the slidable housing 201 of FIG. 5A) may be changed by sliding movement of a second housing part (e.g., the second housing part 220 of FIG. 5A). Based on the change in the size of the slidable housing 201, a mode formed in the electronic device 101 may be determined. For example, a contribution of the first mode, the second mode, and the third mode may be different according to a slide-out length of the second housing part 220.

As described above with reference to FIGS. 6A, 6B, and 6C, flows (L1, L2, L3) of current may be formed differently according to the first mode, the second mode, and/or the third mode. Since the flows of the current are formed differently, radiation patterns formed according to the first mode, the second mode, and/or the third mode may be formed differently. For example, the first mode, the second mode, and/or the third mode may be activated based on a length of a ground of an electronic device (e.g., the electronic device 101 of FIG. 5A). When the length of the ground is changed, a mode formed in the electronic device 101 may be changed, thereby causing a flow of a current corresponding to the changed mode. Based on the flow of the current, a radiation pattern of an antenna (e.g., the antenna 510 of FIG. 5B) may be changed. For example, as a length of the electronic device 101 is changed, adjustment (e.g., enhancement or change) of the radiation pattern with respect to a designated frequency and/or a designated direction may be possible.

A graph 600a of FIG. 6D represents modal significance of the first mode, the second mode, and the third mode when a length of a slidable housing (e.g., the slidable housing 201 of FIG. 5A) with respect to a sliding direction (e.g., y-axis direction of FIG. 5A) of a second housing part (e.g., the second housing part 220 of FIG. 5A) is about 110 mm. For example, modal significance may indicate a degree to which a characteristic mode of a structure contributes to an electromagnetic response of the structure. A first graph 610 of FIG. 6D represents modal significance of the first mode with respect to frequency. A second graph 620 of FIG. 6D represents modal significance of the second mode with respect to frequency. A third graph 630 of FIG. 6D represents modal significance of the third mode with respect to frequency.

Referring to FIG. 6D, with respect to a frequency on about 1.6 GHZ, modal significance of the first mode may be highest, and modal significance of the third mode may be lowest. For example, with respect to the frequency on about 1.6 GHZ, modal significance of the second mode may be about 0.62, and modal significance of the first mode may be about 0.99. For example, when the length of the slidable housing 201 is about 110 mm, since the first mode may be formed most strongly, upward directivity of the radiation pattern may be relatively low.

A graph 600b of FIG. 6E represents modal significance of the first mode, the second mode, and the third mode when a length of the slidable housing 201 with respect to a sliding direction (e.g., the first direction or the second direction of FIG. 5A) of the second housing part 220 is about 155 mm. A fourth graph 640 of FIG. 6E represents modal significance of the first mode with respect to frequency. A fifth graph 650 of FIG. 6E represents modal significance of the second mode with respect to frequency. A sixth graph 660 of FIG. 6E represents modal significance of the third mode with respect to frequency.

Referring to FIG. 6E, with respect to a frequency on about 1.6 GHZ, modal significance of the first mode may be highest, and modal significance of the second mode may be lowest. For example, with respect to the frequency on about 1.6 GHz, modal significance of the second mode may be about 0.86, and modal significance of the first mode may be about 0.94. For example, when the length of the slidable housing 201 is about 155 mm, since the first mode may be formed most strongly and the second mode may be formed most weakly, upward directivity of the radiation pattern may be relatively low.

A graph 600c of FIG. 6F represents modal significance of the first mode, the second mode, and the third mode according to a change in a length of the slidable housing 201 with respect to a sliding direction of the second housing part 220 with respect to a frequency on about 1.6 GHz. A seventh graph 670 of FIG. 6F represents modal significance of the first mode with respect to frequency. An eighth graph 680 of FIG. 6F represents modal significance of the second mode with respect to frequency. A ninth graph 690 of FIG. 6F represents modal significance of the third mode with respect to frequency.

Referring to FIG. 6F, with respect to the frequency on about 1.6 GHZ, the first mode may represent the highest modal significance within a length range of about 110 mm to about 155 mm of the slidable housing 201. For example, the second mode may represent the highest modal significance within a length of about 130 mm of the slidable housing 201 with respect to the frequency on about 1.6 GHz. For example, the third mode may represent modal significance increasing as the length of the slidable housing 201 increases, with respect to the frequency on about 1.6 GHZ.

As described with reference to FIG. 6A, since upward directivity of the radiation pattern is highest in the second mode, a state in which upward directivity of a radiation pattern of an antenna (e.g., the antenna 510 of FIG. 5B) is high may be referred to as a state forming the second mode. Referring to FIGS. 6C, 6E, and 6F, the second mode may represent the highest modal significance at a length of about 130 mm of the slidable housing 201. Referring to FIG. 6F, even when the length of the slidable housing 201 is about 130 mm or more, the second mode may have relatively high modal significance, but modal significance of the third mode also increases as the length increases, and thus formation of the second mode may be hindered. Referring to FIGS. 6A, 6C, 6E, and 6F, when the electronic device 101 has the length of the slidable housing 201 of about 130 mm, the second mode in which upward directivity of the radiation pattern is high may be formed best. For example, the at least one processor 120 may control the driving mechanism 360 to change the length of the slidable housing 201 to about 130 mm, in order to change the electronic device 101 to a state in which upward directivity of the radiation pattern is high. For example, the state in which upward directivity of the radiation pattern is high may be referred to as a state in which the length of the slidable housing 201 is about 130 mm, but it is not limited thereto.

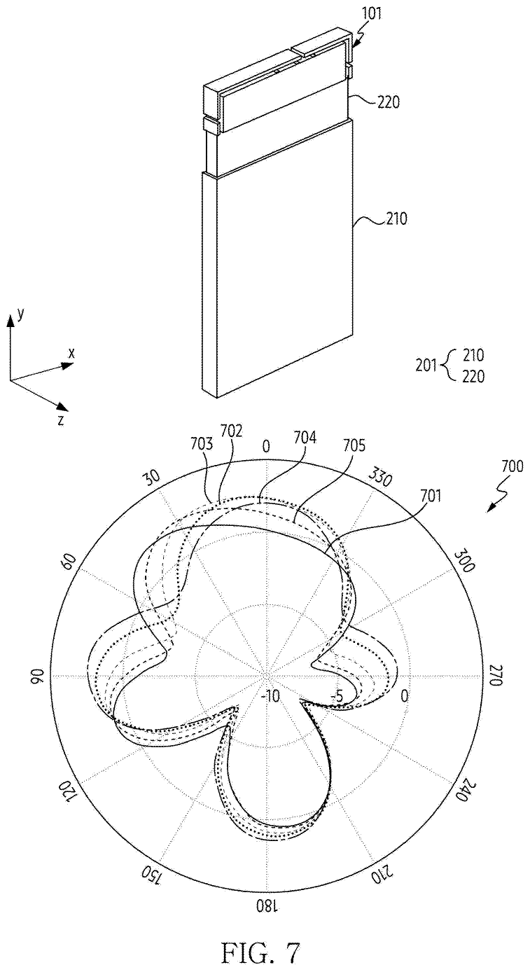

FIG. 7 is a graph representing a radiation pattern of an antenna to a slide-out length of a second housing part according to an embodiment of the disclosure.

Referring to FIG. 7, the second housing part 220 may be slid out in a first direction (e.g., +y direction) or slid in in a second direction (e.g., −y direction), with respect to the first housing part 210. For example, a driving mechanism (e.g., the driving mechanism 360 of FIG. 3A) may be configured to provide a driving force for sliding movement of the second housing part 220.

As described above, a mode formed in the electronic device 101 may be determined based on a length of the slidable housing 201 with respect to a sliding direction (e.g., the first direction or the second direction) of the second housing part 220. The length of the slidable housing 201 may be changed based on a slide-out length of the second housing part 220. For example, in a first state in which the length of the slidable housing 201 is minimum, the slide-out length of the second housing part 220 may be minimum (e.g., 0). For example, in a second state in which the length of the slidable housing 201 is maximum, the slide-out length of the second housing part 220 may be maximum (e.g., about 65 mm).

A graph 700 illustrated in FIG. 7 is a graph representing, on a polar coordinate system, a result of measuring a gain of an antenna (e.g., the antenna 510 of FIG. 5B) including at least one conductive portion among a plurality of conductive portions 530 while rotating an elevation angle with respect to the electronic device 101 having a posture in which an azimuth angle is fixed. The gain may be a gain with respect to a signal on a designated frequency band (e.g., about 1.6 GHz).

A first graph 701 of FIG. 7 represents a radiation pattern of the antenna 510 when a slide-out length of the second housing part 220 is 0. A state in which the slide-out length is 0 may be referred to as a first state in which the second housing part 220 is fully inserted into the first housing part 210. A second graph 702 of FIG. 7 represents the radiation pattern of the antenna 510 when the slide-out length of the second housing part 220 is about 10 mm. A third graph 703 of FIG. 7 represents the radiation pattern of the antenna 510 when the slide-out length of the second housing part 220 is about 20 mm. A fourth graph 704 of FIG. 7 represents the radiation pattern of the antenna 510 when the slide-out length of the second housing part 220 is about 25 mm. A fifth graph 705 of FIG. 7 represents the radiation pattern of the antenna 510 when the slide-out length of the second housing part 220 is about 40 mm.

Referring to the graph 700, as the slide-out length of the second housing part 220 is changed, the radiation pattern of the antenna 510 may also be changed. For example, since the first graph 701 represents the lowest gain with respect to an elevation angle of 0 degrees (e.g., +y direction), the antenna 510 may have the lowest upward directivity when the slide-out length of the second housing part 220 is 0. Since the second graph 702, the third graph 703, and the fourth graph 704 represent high gains with respect to the elevation angle of 0 degrees, the antenna 510 may have relatively high upward directivity when the length of the second housing part 220 is about 10 mm to about 25 mm. The fifth graph 705 may represents a higher gain than the first graph 701 but a lower gain than the second graph 702, the third graph 703, and the fourth graph 704, with respect to the elevation angle of 0 degrees. For example, as the slide-out length of the second housing part 220 increases and a state of the electronic device 101 becomes closer to the second state from the third state, upward directivity may decrease. As described with reference to FIG. 5C, a result corresponding to the highest upward directivity of the radiation pattern of the antenna 510 may be identified when the electronic device 101 is in the third state.

In addition to the above-described examples, the radiation pattern of the antenna 510 may vary according to the slide-out length of the second housing part 220. For example, the memory 130 may store information about the radiation pattern of the antenna 510 according to the slide-out length of the second housing part 220.

For example, the electronic device 101 may receive a signal from the satellite 507 or transmit a signal to the satellite 507. While performing satellite communication, when the electronic device 101 is in a state in which upward directivity of the radiation pattern of the antenna 510 is high, satellite communication efficiency may be improved.

For example, based on the wireless communication circuitry 192 performing communication with an external electronic device (e.g., the satellite 507) using a signal on a designated frequency band (e.g., about 1.6 GHZ), the at least one processor 120 may control the driving mechanism 360 to change the electronic device 101 to the third state. As the state of the electronic device 101 is changed to the third state, satellite communication efficiency may be improved. For example, the at least one processor 120 may identify performance of the communication based on identifying execution of an application providing communication with the satellite 507.

Although, in the above-described description, the third state is described as a state in which upward directivity of the radiation pattern of the antenna 510 is highest, it is not limited thereto. For example, according to a characteristic (e.g., a structure or a material of a housing) of the electronic device 101 or a frequency band, upward directivity of the radiation pattern of the antenna 510 may be high in the first state or the third state. In this case, the at least one processor 120 may change the electronic device 101 to the first state or the second state.

FIG. 8 is a flow chart representing an operation in which an electronic device controls a driving mechanism according to an embodiment of the disclosure.

Operations illustrated in FIG. 8 may be performed when instructions stored in memory (e.g., the memory 130 of FIG. 5B) are individually or collectively executed by at least one processor (e.g., the at least one processor 120 of FIG. 5B).

Referring to FIG. 8, in operation 801, the at least one processor 120 may obtain location information related to a location of an external electronic device stored in the memory 130.

For example, the external electronic device may be referred to as a satellite (e.g., the satellite 507 of FIG. 5A). Since the satellite 507 revolves around the earth along an orbit and the earth on which an electronic device (e.g., the electronic device 101 of FIG. 5A) is located rotates, a relative positional relationship between the electronic device 101 and the satellite 507 may change over time. For example, the memory 130 may store location information related to a location of the satellite 507. The location information related to the location of the satellite 507 may include information about the orbit of the satellite 507. For example, the at least one processor 120 may be configured to obtain location information related to the location of the satellite 507 stored in the memory 130, based on the wireless communication circuitry (e.g., the wireless communication circuitry 192 of FIG. 5B) performing satellite communication using a signal on a designated frequency band (e.g., about 1.6 GHz).

In operation 803, the at least one processor 120 may identify a state in which upward directivity of a radiation pattern of an antenna (e.g., the antenna 510 of FIG. 5B) is high based on the obtained location information.

For example, the at least one processor 120 may be configured to identify a state in which upward directivity of the radiation pattern of the antenna 510 is high based on location information of the satellite 507 and location information (e.g., latitude and longitude) of the electronic device 101. For example, when the location information of the satellite 507 is identified, a relative positional relationship (e.g., an azimuth angle and an elevation angle of the satellite 507) between the electronic device 101 and the satellite 507 may be determined based on the location information of the electronic device 101 and the location information of the satellite 507. For example, the memory 130 may store information about the state in which the upward directivity is high, according to the relative positional relationship between the electronic device 101 and the satellite 507. For example, the information about the state in which the upward directivity is high according to the relative positional relationship may be referred to as information about a slide-out length of a second housing part (e.g., the second housing part 220 of FIG. 5A) corresponding to a relative positional relationship between A and B when the location information of the electronic device 101 is A and the location information of the satellite 507 is B. For example, the at least one processor 120 may obtain information about the slide-out length of the second housing part 220 based on identifying the state stored in the memory 130.

In operation 805, the at least one processor 120 may control a driving mechanism (e.g., the driving mechanism 360 of FIG. 3A) to change the electronic device 101 to the state in which upward directivity is high.

For example, the at least one processor 120 may be configured to control the driving mechanism 360 to change the electronic device 101 to the state in which upward directivity is high obtained in operation 803. For example, the at least one processor 120 may provide a control signal to the driving mechanism 360 such that the second housing part 220 is slid out by the length based on information about the slide-out length of the second housing part 220. For example, the driving mechanism 360 may operate to slide out the second housing part 220 by the length, based on receiving the control signal. As the second housing part 220 is slid out by the length by operation of the driving mechanism 360, a state of the electronic device 101 may be changed to the state in which upward directivity is high. If the state of the electronic device 101 is in the state in which upward directivity is high, the driving mechanism 360 may not operate even though the control signal is received.

When the electronic device 101 performs satellite communication by the operations illustrated in FIG. 8, a state of the electronic device 101 may be in the state in which upward directivity of the radiation pattern of the antenna 510 is high. For example, when a user executes an application for satellite communication, the driving mechanism 360 may be operated by the at least one processor 120, thereby causing sliding movement of the second housing part 220. The electronic device 101 may improve satellite communication efficiency by performing satellite communication in the state in which upward directivity is high.

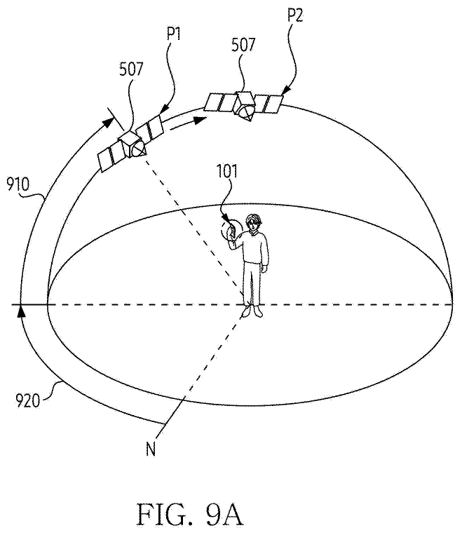

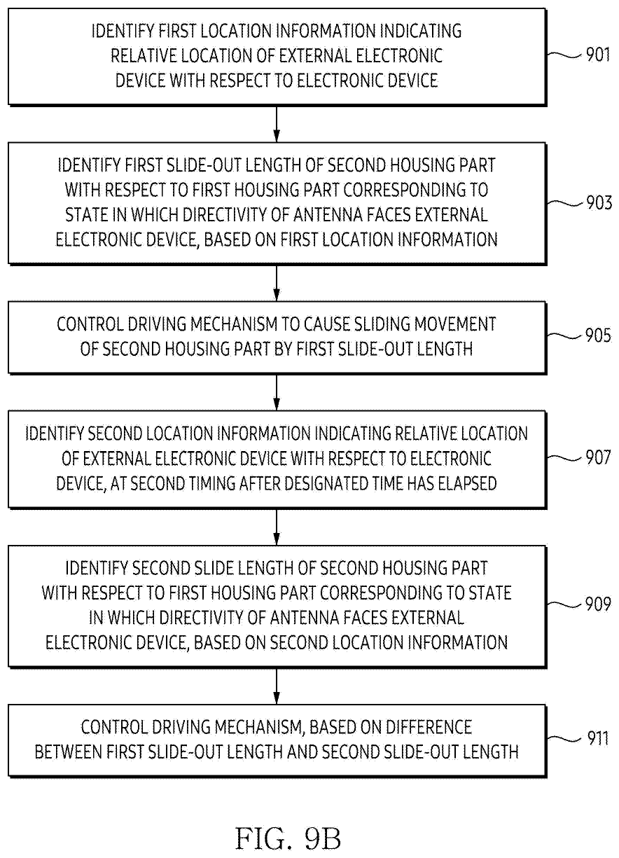

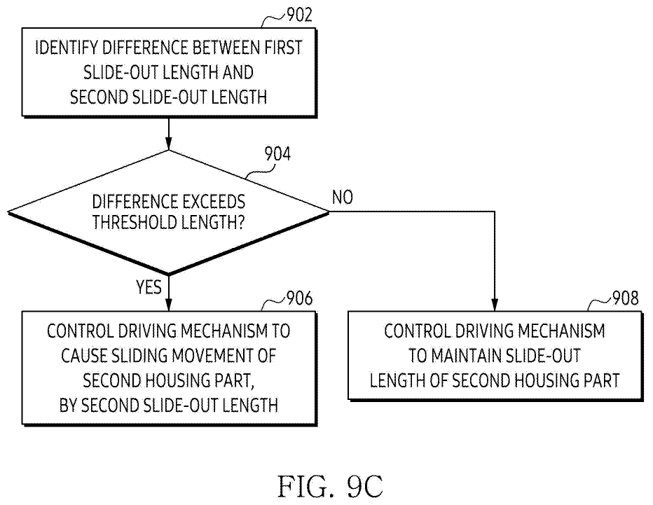

FIG. 9A illustrates a relative positional relationship between an electronic device and an external electronic device according to an embodiment of the disclosure. FIG. 9B is a flow chart representing an operation in which an electronic device identifies a state in which upward directivity is high over time according to an embodiment of the disclosure. FIG. 9C is a flow chart representing an operation in which an electronic device changes a slide-out length according to an embodiment of the disclosure.

Referring to FIG. 9A, a relative positional relationship between the electronic device 101 and an external electronic device (e.g., the satellite 507) may be changed over time.

Since the satellite 507 revolves around the earth along an orbit and the earth on which the electronic device 101 is located rotates, a relative positional relationship between the electronic device 101 and the satellite 507 may change over time. For example, memory (e.g., the memory 130 of FIG. 5B) may store location information related to a location of the satellite 507. The location information about the location of the satellite 507 may include information about the orbit of the satellite 507.

For example, at a first timing, the satellite 507 may be located at a first location P1 on the orbit. While time elapses from the first timing to a second timing, the satellite 507 may revolve along the orbit. For example, since the satellite 507 may be located at a second location P2 on the orbit at the second timing, the relative location between the electronic device 101 and the satellite 507 may be changed. For example, when the electronic device 101 does not move from a location of the electronic device 101 at the first timing, the relative location between the electronic device 101 and the satellite 507 may be changed by rotation of the earth.

For example, when a radiation pattern of an antenna (e.g., the antenna 510 of FIG. 5B) faces the satellite 507, satellite communication efficiency of the electronic device 101 may increase. For example, when directivity of the antenna 510 faces the satellite 507, transmission and/or reception of a signal between the electronic device 101 and the satellite 507 may be smoothly performed. As described with reference to FIG. 7, since the radiation pattern of the antenna 510 is changed as a slide-out length of a second housing part (e.g., the second housing part 220 of FIG. 5A) is adjusted, directivity of the antenna 510 may be finely adjusted. The electronic device 101 may control a driving mechanism (e.g., the driving mechanism 360 of FIG. 3A) to adjust the radiation pattern of the antenna 510 according to a change in a location of the satellite 507 while performing satellite communication.

Operations illustrated in FIG. 9B may be performed when instructions stored in memory (e.g., the memory 130 of FIG. 5B) are individually or collectively executed by at least one processor (e.g., the at least one processor 120 of FIG. 5B).

Referring to FIG. 9B, in operation 901, the at least one processor 120 may identify first location information indicating a relative location of an external electronic device with respect to an electronic device (e.g., the electronic device 101 of FIG. 5A).

For example, the at least one processor 120 may obtain, at a first timing, location information about a location of the satellite 507 stored in the memory 130, based on the wireless communication circuitry (e.g., the wireless communication circuitry 192 of FIG. 5B) performing communication with a satellite (e.g., the satellite 507 of FIG. 5A). For example, the first timing may be a timing at which an application for providing satellite communication is executed, but it is not limited thereto. When the location information is obtained, the at least one processor 120 may identify first location information (e.g., an azimuth angle and an elevation angle) indicating a relative location of the satellite 507 with respect to the electronic device 101, based on location information (e.g., latitude and longitude) of the electronic device 101. For example, the electronic device 101 may include a global positioning system (GPS) sensor used to identify the location information of the electronic device 101. Referring to FIG. 9A, the elevation angle 910 may be referred to as an angle formed between a horizontal plane and a line connecting the satellite 507 and the electronic device 101. The azimuth angle 920 may be referred to as a clockwise angle between a line extending toward the electronic device 101 from a point at which the satellite 507 is projected vertically onto the horizontal plane and a line toward a north pole direction.

In operation 903, the at least one processor 120 may identify a first slide-out length of a second housing part (e.g., the second housing part 220 of FIG. 5A) with respect to a first housing part (e.g., the first housing part 210 of FIG. 5A) corresponding to a state in which directivity of the antenna 510 faces an external electronic device based on the first location information.

For example, when first location information indicating a relative location between the electronic device 101 and the satellite 507 is identified, a state in which the radiation pattern of the antenna 510 faces the satellite 507 may be determined. For example, the memory 130 may store information about the radiation pattern of the antenna 510 according to a slide-out length of the second housing part 220. For example, the at least one processor 120 may identify a state in which directivity of the radiation pattern of the antenna 510 faces the external electronic device (e.g., a state in which upward directivity of the radiation pattern is high), based on the identified first location information and the information about the radiation pattern of the antenna 510 according to the slide-out length of the second housing part 220 stored in the memory 130. When the state is identified, a first slide-out length of the second housing part 220 with respect to the first housing part 210 corresponding to the state may be determined. For example, the at least one processor 120 may identify the first slide-out length.

In operation 905, the at least one processor 120 may control a driving mechanism (e.g., the driving mechanism 360 of FIG. 3A) to cause sliding movement of the second housing part 220 by the first slide-out length.

For example, the at least one processor 120 may control the driving mechanism 360 such that the second housing part 220 is slid by the identified first slide-out length. For example, the at least one processor 120 may provide a control signal to the driving mechanism 360. For example, the driving mechanism 360 may cause sliding movement of the second housing part 220 such that the second housing part 220 is slid by the first slide-out length, based on receiving the control signal. For example, the second housing part 220 may be slid out in a first direction or slid in in a second direction, thereby being slid by the first slide-out length.

For example, the electronic device 101 may perform satellite communication in a state in which the second housing part 220 is slid by the first slide-out length. Since the first slide-out length is in a state in which directivity of the antenna 510 faces the satellite 507, satellite communication efficiency may be improved.

In operation 907, the at least one processor 120 may identify second location information indicating a relative location of an external electronic device with respect to the electronic device 101 at a second timing after a designated time has elapsed.

For example, when the designated time has elapsed, locations of the electronic device 101 and the satellite 507 may be changed. For example, the satellite 507 may revolve along an orbit. For example, the location of the electronic device 101 may be changed by movement of a user or rotation of the earth. For example, the at least one processor 120 may identify second location information through location information about the location of the satellite 507 stored in the memory 130 and location information of the electronic device 101 at a second timing after the designated time has elapsed.

In operation 909, the at least one processor 120 may identify a second slide length of the second housing part 220 with respect to the first housing part 210 corresponding to a state in which directivity of the antenna 510 faces the external electronic device, based on the second location information.

Operation 909 may correspond to operation 903. For example, the at least one processor 120 may identify a state in which directivity of a radiation pattern of the antenna 510 faces an external electronic device (e.g., a state in which upward directivity of the radiation pattern is high), based on the identified second location information and information about the radiation pattern of the antenna 510 according to the slide-out length of the second housing part 220 stored in the memory 130.

In operation 911, the at least one processor 120 may control the driving mechanism 360 based on a difference between the first slide-out length and the second slide-out length.

For example, as time elapses, a difference between the first location information at the first timing and the second location information at the second timing may occur. For example, when the location of the electronic device 101 is not changed or the designated time is relatively short compared to a revolution period of the satellite 507, the difference may be small. For example, when the difference is small, since a state in which directivity of the antenna 510 faces the satellite 507 is substantially the same or similar, a difference between the first slide-out length and the second slide-out length may be small. In this case, the at least one processor 120 may control the driving mechanism 360 such that the slide-out length of the second housing part 220 is maintained as the first slide-out length.

For example, when the location of the electronic device 101 is changed or the designated time is relatively long compared to the revolution period of the satellite 507, the difference may be large. For example, when the difference is large, a state in which directivity of the antenna 510 faces the satellite 507 may be different. When the state is different, a difference between the first slide-out length and the second slide-out length may be large. In this case, in order to change the state of the electronic device 101 to a state having higher satellite communication efficiency, the at least one processor 120 may control the driving mechanism 360 such that a slide-out length of the second housing part 220 is changed to the second slide-out length.

Operations illustrated in FIG. 9C may be performed when instructions stored in memory (e.g., the memory 130 of FIG. 5B) are individually or collectively executed by at least one processor (e.g., the at least one processor 120 of FIG. 5B).

In the disclosure, expressions of exceeding or being less than or equal to may be used to determine whether a specific condition is satisfied or fulfilled, but this is merely a description for expressing an example and does not exclude descriptions of greater than or equal to or less than. A condition described as “exceeding” may be replaced with “greater than or equal to,” and a condition described as “less than or equal to” may be replaced with “less than.”

Referring to FIG. 9C, in operation 902, the at least one processor 120 may identify a difference between the first slide-out length and the second slide-out length.

For example, the at least one processor 120 may be configured to compare the first slide-out length and the second slide-out length and identify the difference.

In operation 904, the at least one processor 120 may identify whether the difference exceeds a threshold length.

For example, the at least one processor 120 may compare the difference between the first slide-out length and the second slide-out length with the threshold length and identify whether the difference exceeds the threshold length. For example, the threshold length may be determined based on a degree to which a change of the radiation pattern of the antenna 510 due to the difference affects satellite communication efficiency. For example, the difference exceeding the threshold length may be referred to as causing a change of the radiation pattern of the antenna 510 due to the difference to a degree affecting satellite communication efficiency.

When the difference exceeds the threshold length, operation 906 may be performed, and when the difference does not exceed the threshold length, operation 908 may be performed.

In operation 906, the at least one processor 120 may control the driving mechanism 360 to cause sliding movement of the second housing part 220 by the second slide-out length.

For example, the at least one processor 120 may control the driving mechanism 360 to cause sliding movement of the second housing part 220 by the second slide-out length, based on identifying that the difference exceeds the threshold length. For example, the at least one processor 120 may provide a control signal to the driving mechanism 360. For example, the driving mechanism 360 may cause sliding movement of the second housing part 220, based on receiving the control signal. For example, the second housing part 220 may slide from the first slide-out length to the second slide-out length by the driving mechanism 360.

For example, while the electronic device 101 performs satellite communication, the electronic device 101 may improve satellite communication efficiency by finely adjusting the slide-out length of the second housing part 220. For example, as the second housing part 220 is slid by the second slide-out length, the electronic device 101 may perform satellite communication in a state in which directivity of the antenna 510 faces the satellite 507. As the electronic device 101 performs satellite communication in the state, satellite communication efficiency may be improved.

In operation 908, the at least one processor 120 may control the driving mechanism 360 to maintain the slide-out length of the second housing part 220.

For example, the at least one processor 120 may control the driving mechanism 360 to maintain the second slide-out length, based on identifying that the difference is less than or equal to the threshold length. For example, the second housing part 220 may maintain a state of being slid by the first slide-out length identified at the first timing. For example, in operation 908, unless sliding movement of the second housing part 220 is caused by an external force, the at least one processor 120 may not control the driving mechanism 360. Since the difference between the first slide-out length and the second slide-out length is small, when a state in which directivity of the antenna 510 faces the satellite 507 is substantially maintained, power consumption due to unnecessary control of the driving mechanism 360 may be reduced.

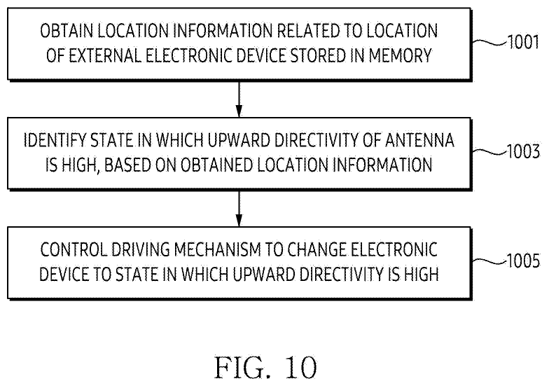

FIG. 10 is a flow chart representing a process in which an electronic device searches for a state in which upward directivity is high according to an embodiment of the disclosure.

As described above, a radiation pattern of an antenna (e.g., the antenna 510 of FIG. 5B) may be changed based on a slide-out length of a second housing part (e.g., the second housing part 220 of FIG. 5A). Since a difference in directivity of the antenna 510 due to a change of the radiation pattern of the antenna 510 affects satellite communication efficiency, satellite communication efficiency may be improved as the at least one processor 120 controls a driving mechanism (e.g., the driving mechanism 360 of FIG. 3A) such that an electronic device (e.g., the electronic device 101 of FIG. 5A) is changed to a state in which upward directivity of the radiation pattern of the antenna 510 is high. For example, memory (e.g., the memory 130 of FIG. 5B) may store information about the radiation pattern of the antenna 510 according to the slide-out length of the second housing part 220, and the at least one processor 120 may identify the state in which upward directivity is high through the information. In an example, when the information is not stored in the memory 130, the electronic device 101 may search for the state in which upward directivity is high, based on performing satellite communication.

In operation 1001, the at least one processor 120 may control the driving mechanism 360 such that the electronic device 101 is respectively changed to a first state, a second state, and a third state over a designated time.

For example, the at least one processor 120 may slide the second housing part 220 to search for a state in which upward directivity of the radiation pattern of the antenna 510 is high. For example, the at least one processor 120 may control the driving mechanism 360 to change the electronic device 101 to the first state, the second state, and/or the third state, based on the wireless communication circuitry 192 performing satellite communication. For example, when performance of the satellite communication is started, the electronic device 101 may be changed to the first state, the second state, and/or the third state over a designated time. For example, when the electronic device 101 starts performance of satellite communication in the first state, the second housing part 220 may be slid out, and thus the electronic device 101 may be changed from the first state to the second state through the third state, over the designated time. For example, the electronic device 101 may be in the first state, the third state, and the second state during the designated time. For example, the wireless communication circuitry 192 may receive a signal from the satellite 507 in the first state, the second state, and the third state through operation 1001.

In operation 1003, the at least one processor 120 may identify quality of a signal received from the external electronic device in the first state, the second state, and the third state.

For example, the at least one processor 120 may identify quality of a signal received from the satellite 507 in the first state, the second state, and the third state to search for a state in which upward directivity of the radiation pattern of the antenna 510 is high. For example, the at least one processor 120 may identify a first reception quality indicating reception quality of a first signal received in the first state, a second reception quality indicating reception quality of a second signal received in the second state, and a third reception quality indicating reception quality of a third signal received in the third state. For example, the third reception quality may include quality for a plurality of signals. For example, since the third state includes a plurality of intermediate states, the at least one processor 120 may identify a plurality of third reception qualities distinguished for each designated length (e.g., 5 mm) in the third state.

For example, in the disclosure, signal quality may include at least one of reference signal received power (RSRP), beam reference signal received power (BRSRP), reference signal received quality (RSRQ), received signal strength indicator (RSSI), signal to interference and noise ratio (SINR), carrier to interference and noise ratio (CINR), signal to noise ratio (SNR), error vector magnitude (EVM), bit error rate (BER), and block error rate (BLER). In addition to the above-described examples, other terms having equivalent technical meanings or other metrics indicating channel quality may be used.

In operation 1005, the at least one processor 120 may control the driving mechanism 360 based on quality of a signal.

For example, the at least one processor 120 may compare the first reception quality, the second reception quality, and the third reception quality. For example, the at least one processor 120 may be configured to control the driving mechanism 360 based on a state of the electronic device 101 corresponding to a signal indicating the highest quality according to a result of the comparison.

For example, high signal quality may be referred to as a case in which a signal quality value related to signal strength is large or a signal quality value related to an error rate is small. For example, as signal quality increases, a smooth wireless communication environment may be ensured. For example, when reception quality of a third signal is high, it may be referred to that the radiation pattern of the antenna 510 has the highest upward directivity in the third state. For example, when the third reception quality includes a plurality of reception qualities obtained for each designated length, the at least one processor 120 may identify a state corresponding to a signal indicating the highest reception quality among the plurality of third reception qualities. For example, the at least one processor 120 may identify a slide-out length of the second housing part 220 corresponding to the state, based on identifying the state. For example, the at least one processor 120 may be configured to control the driving mechanism 360 such that the second housing part 220 is slid out by the identified slide-out length.

The electronic device 101 may search for a state in which upward directivity of the radiation pattern of the antenna 510 is high through operations illustrated in FIG. 10 and may perform satellite communication based on the state.

FIGS. 11A, 11B, 11C, and 11D illustrate various structures of a second housing part according to various embodiments of the disclosure.

Referring to FIG. 11A, an electronic device (e.g., the electronic device 101 of FIG. 5A) may include a plurality of conductive portions 530 formed along at least a portion of edges of the second housing part 220. For example, the plurality of conductive portions 530 may be electrically separated by a plurality of non-conductive portions 540. For example, the second housing part 220 may include a support member 520 and a side frame 521.

For example, the second housing part 220 may include a first edge 551, a second edge 552, a third edge 553, and a fourth edge 554. For example, the first edge 551 may be disposed in a slide-out direction (e.g., +y direction) of the second housing part 220. For example, the second edge 552 may be disposed perpendicular to the first edge 551 from an end of the first edge 551. For example, the third edge 553 may be opposite to the second edge 552. For example, the first edge 551 may be an edge in +y direction. For example, the second edge 552 may be an edge in −x direction. For example, the third edge 553 may be an edge in +x direction. For example, the fourth edge 554 may be opposite to the first edge 551. For example, the fourth edge 554 may be an edge in −y direction.

For example, the plurality of conductive portions 530 may be at least partially formed along the first edge 551, the second edge 552, and the third edge 553. Referring to FIG. 11A, the plurality of conductive portions 530 may include a first conductive portion 531 and a second conductive portion 532. For example, the first conductive portion 531 may be formed between a first non-conductive portion 541 in the second edge 552 and a second non-conductive portion 542 in the first edge 551. For example, the second conductive portion 532 may be formed between the second non-conductive portion 542 and a third non-conductive portion 543 in the third edge 553.

For example, the second housing part 220 may include a plurality of opening regions 550 between the support member 520 and the side frame 521. For example, the support member 520 and the side frame 521 may be partially spaced apart by the plurality of opening regions 550. For example, when a non-conductive material is filled in the plurality of opening regions 550, at least a portion of the plurality of opening regions 550 may be referred to as a slot 560 or a slit for electrically separating the plurality of conductive portions 530 and the support member 520. For example, the slot 560 may include poly carbonate (PC), but it is not limited thereto. For example, the slot 560 may form the plurality of non-conductive portions 540 by filling between the plurality of conductive portions 530. For example, the plurality of non-conductive portions 540 formed between the plurality of conductive portions 530 may limit a length of a conductive portion operating as an antenna radiator as a dielectric.

For example, the first conductive portion 531 may include a first feeding point F1 electrically connected with the wireless communication circuitry 192. For example, the second conductive portion 532 may include a second feeding point F2 and/or a third feeding point F3 electrically connected with the wireless communication circuitry 192. For example, when a first signal is provided to the first feeding point F1 from the wireless communication circuitry 192, the first conductive portion 531 may operate as an antenna radiator for transmitting the first signal. For example, when the first signal is provided to the second feeding point F2 from the wireless communication circuitry 192, the second conductive portion 532 may operate as an antenna radiator for transmitting a second signal. For example, when a third signal is provided to the third feeding point F3 from the wireless communication circuitry 192, the second conductive portion 532 may operate as an antenna radiator for transmitting the third signal.

For example, since the first conductive portion 531 and the second conductive portion 532 are located on an upper portion (e.g., +y direction) of the second housing part 220, the first conductive portion 531 and the second conductive portion 532 may be used as antenna radiators of the satellite antenna 510 for satellite communication. For example, since the satellite 507 is located upward (e.g., ty direction) with respect to the electronic device 101, an antenna including at least a portion of the first conductive portion 531 and an antenna including at least a portion of the second conductive portion 532 may be suitable for transmitting a signal upward. For example, the wireless communication circuitry 192 may be configured to communicate with the satellite 507 by feeding the second feeding point F2 or the third feeding point F3 of the second conductive portion 532.

For example, segmented structures of the second housing part 220 may be implemented in various ways. Even when the segmented structure of the second housing part 220 is changed, the at least one processor 120 may identify a state in which upward directivity of the radiation pattern is high, by using a change in the radiation pattern according to the slide-out length of the second housing part 220. Hereinafter, various structures of the second housing part 220 are described.

Referring to FIG. 11B, a side (e.g., the second edge 552 and the third edge 553) of the second housing part 220 may have an asymmetric structure. For example, the second non-conductive portion 542 formed in the first edge 551 may be formed in a middle portion of the first edge 551. For example, the first non-conductive portion 541 may be located closer to the first edge 551 than the third non-conductive portion 543. For example, a distance between the first edge 551 and the first non-conductive portion 541 may be smaller than a distance between the first edge 551 and the third non-conductive portion 543.

For example, the first conductive portion 531 and/or the second conductive portion 532 formed at least partially in the first edge 551 may operate as an antenna radiator for a satellite antenna. For example, the wireless communication circuitry 192 may be configured to communicate with the satellite 507 by feeding the first feeding point F1 of the first conductive portion 531 and/or the second feeding point F2 of the second conductive portion 532.

Referring to FIG. 11C, a plurality of non-conductive portions may be formed in the first edge 551. For example, the plurality of conductive portions 530 may include a first conductive portion 531, a second conductive portion 532, a third conductive portion 533, and/or a fourth conductive portion 534. For example, the first conductive portion 531 may be formed between the first non-conductive portion 541 in the second edge 552 and the second non-conductive portion 542 in the first edge 551. For example, the second conductive portion 532 may be formed between the second non-conductive portion 542 and the third non-conductive portion 543 in the first edge 551. For example, the third conductive portion 533 may be formed between the third non-conductive portion 543 and the fourth non-conductive portion 544 in the third edge 553. For example, the fourth conductive portion 534 may be formed between the first non-conductive portion 541 and a point P at which the side frame 521 contacts the support member 520.

For example, the second conductive portion 532 and/or the third conductive portion 533 formed at least partially in the first edge 551 may operate as an antenna radiator for a satellite antenna. For example, the wireless communication circuitry 192 may be configured to communicate with the satellite 507 by feeding the second feeding point F2 of the second conductive portion 532 and/or the third feeding point F3 of the third conductive portion 533.

Referring to FIG. 11D, a plurality of non-conductive portions may be formed in a side (e.g., the second edge 552 and the third edge 553) of the second housing part 220. For example, the plurality of conductive portions 530 may include the first conductive portion 531, the second conductive portion 532, the third conductive portion 533, the fourth conductive portion 534, and/or the fifth conductive portion 535. For example, the first conductive portion 531 may be formed between the first non-conductive portion 541 in the second edge 552 and the second non-conductive portion 542 in the first edge 551. For example, the second conductive portion 532 may be formed between the second non-conductive portion 542 and the third non-conductive portion 543 in the first edge 551. For example, the third conductive portion 533 may be formed between the third non-conductive portion 543 and the fourth non-conductive portion 544 in the third edge 553. For example, the fourth conductive portion 534 may be formed between the first non-conductive portion 541 and the fifth non-conductive portion 545 in the second edge 552. For example, the fifth conductive portion 535 may be formed between the fourth non-conductive portion 544 and the sixth non-conductive portion 546 in the third edge 553.

For example, the first conductive portion 531, the second conductive portion 532, and/or the third conductive portion 533 formed at least partially in the first edge 551 may operate as an antenna radiator for a satellite antenna. For example, the wireless communication circuitry 192 may be configured to communicate with the satellite 507 by feeding the first feeding point F1 of the first conductive portion 531, the second feeding point F2 of the second conductive portion 532, and/or the third feeding point of the third conductive portion 533.

The above-described descriptions may be applied substantially equally to the second housing part 220 illustrated in FIGS. 11A to 11D. For example, an antenna including at least a portion of a conductive portion disposed at least partially in the first edge 551 of an upper end may be used for satellite communication. For example, the at least one processor 120 may improve satellite communication efficiency by controlling the driving mechanism 360, based on a state in which upward directivity of the radiation pattern of the antenna 510 is high.

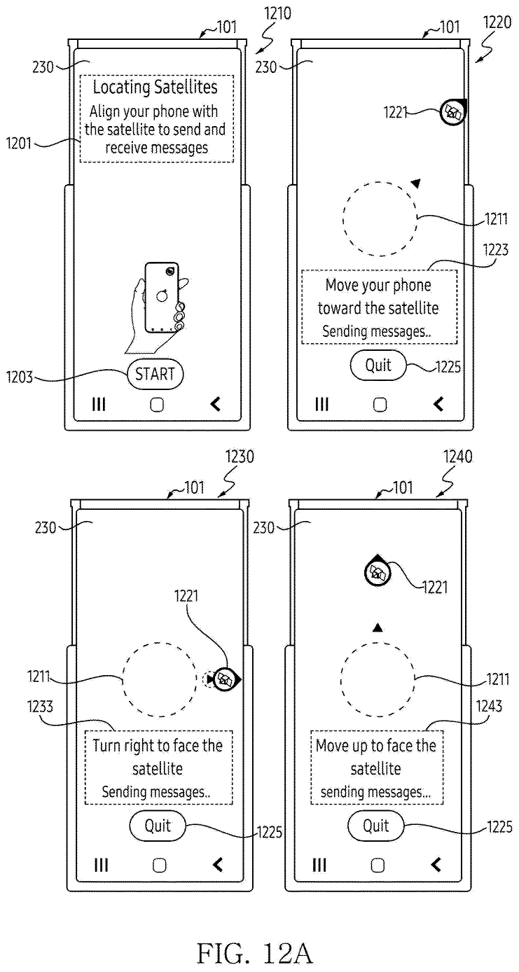

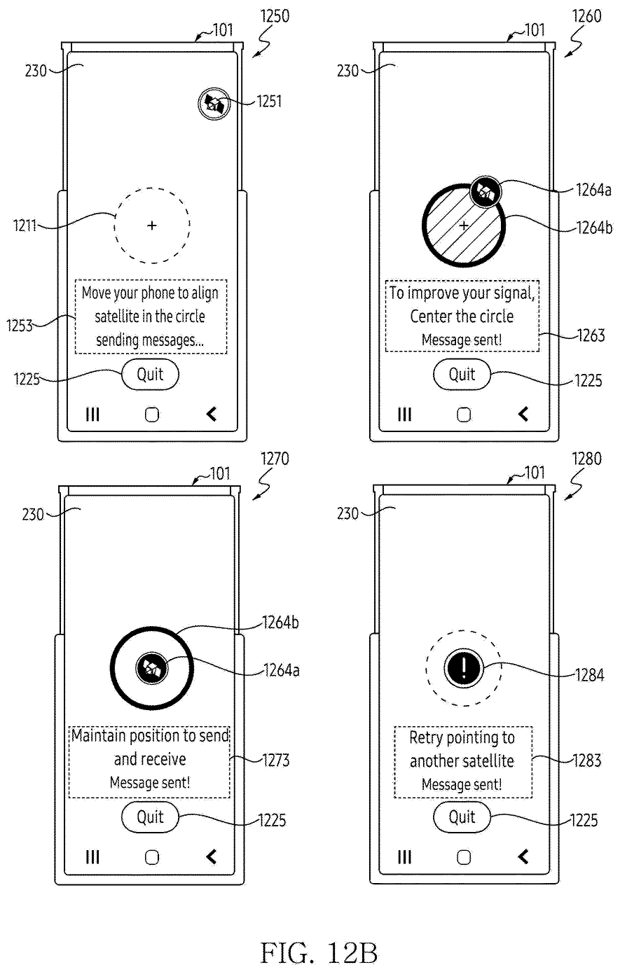

FIGS. 12A and 12B illustrate an example of a screen for guiding a relative location of a satellite for satellite communication according to various embodiments of the disclosure.

Referring to FIG. 12A, a screen 1210, a screen 1220, a screen 1230, and/or a screen 1240 may be displayed on a flexible display (e.g., the display 230 of FIG. 3A) of the electronic device 101.

For example, in the screen 1210, the electronic device 101 may display text 1201 and/or a button 1203 on the screen 1210.

For example, in the screen 1220, the electronic device 101 may display a first indicator 1221, a second indicator 1211, text 1223, and/or a button 1225 on the screen 1220.

For example, in the screen 1230, the electronic device 101 may display the first indicator 1221, the second indicator 1211, text 1233, and/or the button 1225 on the screen 1230.

For example, in the screen 1240, the electronic device 101 may display the first indicator 1221, the second indicator 1211, text 1243, and/or the button 1225 on the screen 1240.

The first indicator 1221 may indicate a location of a satellite (e.g., the satellite 507 of FIG. 5A). For example, the first indicator 1221 may indicate a relationship between a location of the satellite located at upper portion with respect to the electronic device 101 and an actual location of the satellite. The second indicator 1211 may include an object (e.g., a circular window) indicating a direction. For example, the second indicator 1211 may indicate an approximate direction of the satellite and a direction in which the electronic device 101 should move.

For example, a user may execute an application for performing satellite communication through the electronic device 101. For example, the satellite communication may be used in a situation in which cellular communication or network communication requiring a base station is difficult. For example, the satellite communication may be used when the electronic device 101 receives a signal from a satellite navigation device (e.g., global positioning system (GPS)) and/or when the electronic device 101 provides a non-terrestrial network service using a 5G non-terrestrial network (5G NTN). The electronic device 101 may provide an emergency rescue service by using a connection with a satellite in an idle state of a terrestrial network.

For example, the electronic device 101 may identify direction information of a satellite based on location information of the electronic device 101 and location information of the satellite. The electronic device 101 may display, on a guide screen displayed through the flexible display 230, an indicator (e.g., the second indicator 1211) for guiding a location of the electronic device 101, based on the direction information of the satellite and direction information of the electronic device 101. A user may change a direction of the electronic device 101, based on the guide screen. An antenna of the electronic device 101 may be disposed to face the satellite as the direction of the electronic device 101 is changed.

Hereinafter, a screen (e.g., the screen 1210 to the screen 1280) displayed to guide the location of the electronic device 101 such that the antenna is disposed toward the satellite are described.

For example, on the screen 1210, the electronic device 101 may execute an application for satellite communication. For example, the application for satellite communication may be referred to as an application for transmitting a message to a satellite. The electronic device 101 may guide the satellite search function by displaying text 1201 through the flexible display 230. For example, the electronic device 101 may display the text 1201 such as “Align your phone with the satellite to send and receive messages” on the flexible display 230. For example, the electronic device 101 may display a button 1203 for initiating the satellite search function of the application for satellite communication on the flexible display 230. When an input for the button 1203 is identified, the electronic device 101 may perform the satellite search function.

The screen 1220 may be displayed when movement of the electronic device 101 is required. For example, on the screen 1220, the electronic device 101 may display a satellite outside a designated range on the flexible display 230. The designated range may be an angular range in which the satellite may be displayed within a screen of the electronic device 101. The electronic device 101 may indicate a location of the satellite through a first indicator 1221. For example, on the screen 1220, the electronic device 101 may display a second indicator 1211 for guiding a direction on the flexible display 230. On the screen 1220, the electronic device 101 may guide a movement direction of the electronic device 101 to a user through text 1223. For example, the electronic device 101 may display text 1223 such as “Move your phone toward the satellite” on the flexible display 230. Additionally, the electronic device 101 may display a phrase indicating that transmission is in progress (e.g., sending messages) on the flexible display 230.

The screen 1230 may be displayed when a change in direction and/or posture of the electronic device 101 is required. For example, on the screen 1230, the electronic device 101 may display the first indicator 1221 indicating a location of the satellite and the second indicator 1211 for guiding a direction on the flexible display 230. On the screen 1230, the electronic device 101 may guide a posture and/or a direction of the electronic device 101 to a user through text 1233. For example, the electronic device 101 may display the text 1233 such as “Turn right to face the satellite” on the flexible display 230. Additionally, the electronic device 101 may display a phrase indicating that transmission is in progress (e.g., sending messages) on the flexible display 230.

The screen 1240 may be displayed when a change in location (e.g., height) of the electronic device 101 is required. For example, on the screen 1240, the electronic device 101 may display the first indicator 1221 identified based on direction information of the electronic device 101 and direction information of the satellite within the screen 1240. For example, the first indicator 1221 may be a visual object for indicating a location of the satellite. For example, the first indicator 1221 may include an icon (e.g., an icon schematically illustrating the satellite). However, it is not limited thereto.

For example, a difference between direction information of the electronic device 101 displaying the screen 1240 and direction information of the satellite may be outside a designated range. The first indicator 1221 may indicate to a point outside the flexible display to indicate a satellite outside the designated range. The designated range may be an angular range in which the satellite may be displayed within a screen of the electronic device 101.

For example, the electronic device 101 may display the second indicator 1211 for guiding a direction of the electronic device 101 within the screen 1240. For example, the second indicator 1211 may be a visual object for providing guidance for the direction of the electronic device 101. For example, the second indicator 1211 may be displayed with a shape of dashed circle and an arrow near the dashed circle. However, embodiments of the disclosure may not be limited thereto. For example, on the screen 1240, the electronic device 101 may display the text 1243 such as “Move up to face the satellite” on the flexible display 230. On the screen 1240, the electronic device 101 may display the button 1225 for stopping the satellite search function on the flexible display 230. When an input for the button 1225 is identified, the electronic device 101 may stop the satellite search function.

Referring to FIG. 12B, a screen 1250, a screen 1260, a screen 1270, and/or a screen 1280 may be displayed on the flexible display 230 of the electronic device 101.

For example, the electronic device 101 may display text 1253, a button 1225, a first indicator 1251, and/or a second indicator 1211 on the screen 1250. The electronic device 101 may display text 1263, a button 1225, a first indicator 1264a, and/or a second indicator 1264b on the screen 1260. The electronic device 101 may display text 1273, a button 1225, a first indicator 1264a, and/or a second indicator 1264b on the screen 1270. The electronic device 101 may display text 1283, a button 1225, and/or an indicator 1284 on the screen 1280.

For example, on the screen 1250, a difference between direction information of the electronic device 101 and direction information of the satellite may be within a designated range. For example, the first indicator 1251 corresponding to the satellite may be displayed within the screen 1250. A form of the first indicator 1251 in a case that the difference between the direction information of the electronic device 101 and the direction information of the satellite is within the designated range may be different from a form of the first indicator (e.g., the first indicator 1221 of FIG. 12A) in a case that the difference between the direction information of the electronic device 101 and the direction information of the satellite is outside the designated range. For example, the first indicator 1221 in the case that the difference between the direction information of the electronic device 101 and the direction information of the satellite is outside the designated range may be an icon displayed on an outer boundary within a designated range of a screen (e.g., the screen 1220 of FIG. 12A) and indicating a point outside the screen. For example, the first indicator 1251 in the case that the difference between the direction information of the electronic device 101 and the direction information of the satellite is within the designated range may be an icon indicating a point within the screen. In addition, a portion (e.g., an arrow) of the second indicator 1211 for providing guidance for a direction of the electronic device 101 may be removed on the flexible display 230. When the satellite is displayed on the screen of the electronic device 101, the second indicator 1211 may provide “+” within a circle to indicate a center line for the satellite. The electronic device 101 may guide the direction of the electronic device 101 by displaying the text 1253. The electronic device 101 may display the text 1253 such as “move your phone to align satellite in the circle” on the flexible display 230. On the screen 1250, the electronic device 101 may display the button 1225 for stopping the satellite search function on the flexible display 230. When an input for the button 1225 is identified, the electronic device 101 may stop the satellite search function.

For example, on the screen 1260, the electronic device 101 may identify the second indicator 1264b overlapping with the first indicator 1264a on the screen 1260, due to a change in direction of the electronic device 101. For example, the electronic device 101 may change a state of the first indicator 1264a, based on identifying the second indicator 1264b overlapping with the first indicator 1264a on the screen 1260. For example, a state (e.g., a state according to transparency, a state according to color, a state according to shape, or a state according to complexity) of the first indicator 1264a overlapping with the second indicator 1264b on the screen 1260 may be different from a state (e.g., a state according to transparency, a state according to color, a state according to shape, or a state according to complexity) of the first indicator 1264a spaced apart from the second indicator 1264b on the screen 1260. For example, the electronic device 101 may change a state of the second indicator 1264b based on identifying the second indicator 1264b overlapping with the first indicator 1264a on the screen 1260. For example, a state (e.g., transparency, color, shape, or complexity) of the second indicator 1264b overlapping with the first indicator 1264a on the screen 1260 may be different from a state (e.g., transparency, color, shape, or complexity) of the second indicator 1264b spaced apart from the first indicator 1264a on the screen 1260. For example, on the screen 1260, the electronic device 101 may display the text 1263 such as “To improve your signal, center the circle” on the flexible display 230. On the screen 1260, the electronic device 101 may display the button 1225 for stopping the satellite search function on the flexible display 230. When an input for the button 1225 is identified, the electronic device 101 may stop the satellite search function.

For example, on the screen 1270, based on identifying a difference between direction information of the electronic device 101 and direction information of the satellite being within the designated second range, the electronic device 101 may transmit, through the wireless communication circuitry (e.g., the wireless communication circuitry 192 of FIG. 5B), a signal including content of a message to the satellite. For example, the electronic device 101 may visually display, on the flexible display 230, a state of the electronic device 101 transmitting and/or receiving a signal, based on a change in a characteristic (e.g., color, rotation, or transparency) of the first indicator 1264a. For example, the electronic device 101 may visually display, on the flexible display 230, a state of the electronic device 101 transmitting a signal, based on a change in a characteristic (e.g., color, rotation, or transparency) of the second indicator 1264b. For example, a color of the second indicator 1264b may be changed based on a designated period. For example, the second indicator 1264b may be displayed to rotate according to the designated period. For example, on the screen 1270, the electronic device 101 may display the text 1273 such as “maintain position to send and receive” on the flexible display 230. On the screen 1270, the electronic device 101 may display the button 1225 for stopping the satellite search function on the flexible display 230. When an input for the button 1225 is identified, the electronic device 101 may stop the satellite search function.

For example, on the screen 1280, the electronic device 101 may indicate failure of transmission and/or failure of reception of a message by satellite communication through the flexible display 230. For example, the electronic device 101 may indicate the failure of transmission and/or the failure of reception of the message, by displaying the indicator 1284 on the flexible display 230. For example, on the screen 1280, the electronic device 101 may display the text 1283 such as “retry pointing to another satellite” on the flexible display 230. On the screen 1280, the electronic device 101 may display the button 1225 for stopping the satellite search function on the flexible display 230. When an input for the button 1225 is identified, the electronic device 101 may stop the satellite search function.

For example, direction information of a satellite may be referred to as angle information of the satellite. The direction information of the satellite may include height information of the satellite and distance information of the satellite. The height information of the satellite may include elevation angle information of the satellite. The distance information of the satellite may include azimuth angle information of the satellite.

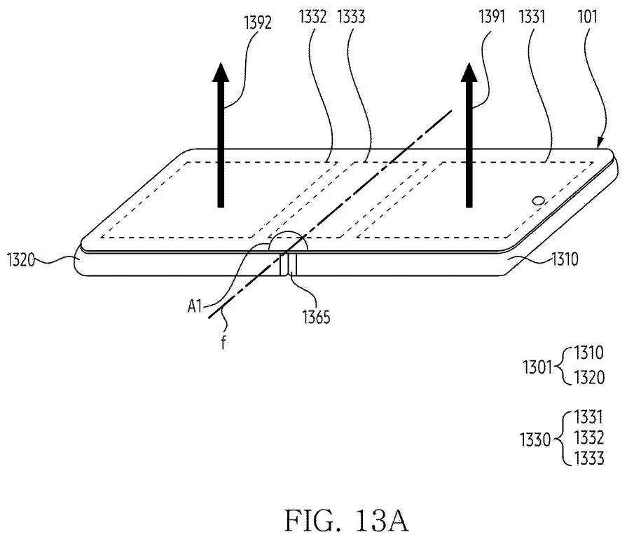

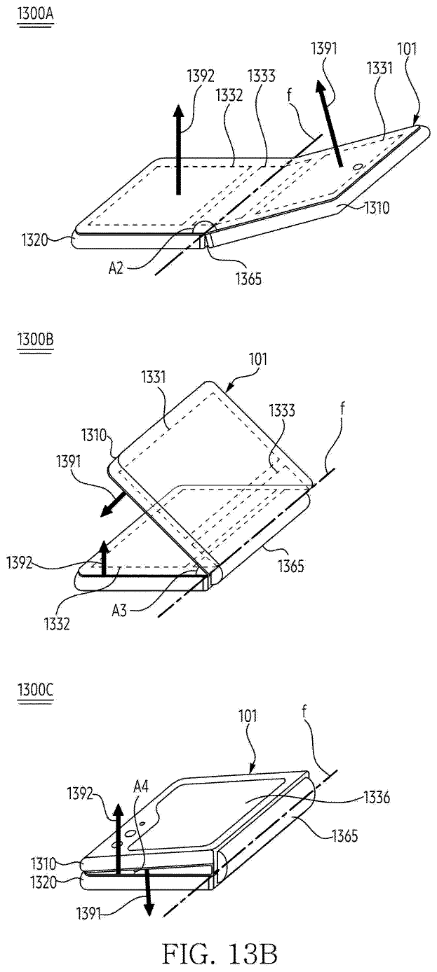

The above-described electronic device 101 has been described as including the slidable housing 201, but it is not limited thereto. For example, a structure of the electronic device 101 may vary. For example, the electronic device 101 may include a foldable housing (e.g., the foldable housing 1301 of FIG. 13A). Hereinafter, the electronic device 101 including the foldable housing is described. Except that a structure of a deformable housing is different, descriptions about the above-described electronic device 101 may be applied substantially equally to the electronic device 101 described below.

FIG. 13A illustrates an unfolding state of an electronic device according to an embodiment of the disclosure. FIG. 13B illustrates intermediate states and a folding state of an electronic device according to an embodiment of the disclosure.

Referring to FIGS. 13A and 13B, the electronic device 101 may include a foldable housing 1301. For example, the foldable housing 1301 may include a first housing part 1310 and a second housing part 1320.

For example, the first housing part 1310 and the second housing part 1320 may be rotatably coupled with respect to a folding axis f. For example, the second housing part 1320 may be rotatably coupled to the first housing part 1310. For example, the electronic device 101 may include a hinge structure 1365 for rotatably connecting the first housing part 1310 and the second housing part 1320. For example, the hinge structure 1365 may enable the electronic device 101 to change from an unfolding state to a folding state. For example, the hinge structure 1365 may enable the electronic device 101 to change from the folding state to the unfolding state. For example, the hinge structure 1365 may maintain the electronic device 101 in an intermediate state between the unfolding state and the folding state. The intermediate state may be referred to as a state between the folding state and the unfolding state.

For example, the unfolding state may be referred to as a first state. For example, the folding state may be referred to as a second state. For example, the intermediate state may be referred to as a third state.

For example, the electronic device 101 may include a flexible display 1330. The flexible display 1330 may be disposed on the first housing part 1310 and the second housing part 1320. For example, the flexible display 1330 may include a first region 1331, a second region 1332, and a third region 1333. The first region 1331 may be disposed on the first housing part 1310. The second region 1332 may be disposed on the second housing part 1320. The third region 1333 may be disposed between the first region 1331 and the second region 1332. The third region 1333 may be disposed along the folding axis f.

The electronic device 101 may provide a first state in which the first housing part 1310 and the second housing part 1320 are fully folded out by the hinge structure 1365. For example, referring to FIG. 13A, the electronic device 101 may be in the first state. For example, the first state may indicate a state in which a first direction 1391 toward which the first region 1331 faces corresponds to a second direction 1392 toward which the second region 1332 faces. For example, in the first state, the first direction 1391 may be parallel to the second direction 1392. For example, in the first state, the first direction 1391 may be substantially the same as the second direction 1392.

For example, in the first state, the first region 1331 may form substantially the same plane as the second region 1332. For example, in the first state, an angle A1 between the first region 1331 and the second region 1332 may be about 180 degrees. For example, the first state may indicate a state in which the entire display area of the flexible display 1330 may be provided substantially on a plane. For example, the first state may indicate a state in which all of the first state, the first region 1331, the second region 1332, and the third region 1333 may be provided on a plane. For example, the first state may be referred to as an unfolded state. Hereinafter, different states of the electronic device 101 based on an angle (e.g., the angles A2, A3, and A4 of FIG. 13B) are described. For example, the angles may be replaced with an angle between the first housing part 1310 and the second housing part 1320.

Referring to FIG. 13B, the electronic device 101 may provide a second state in which the first housing part 1310 and the second housing part 1320 are folded by the hinge structure 1365.

For example, the electronic device 101 may be in a third state between the first state and the second state. For example, a state 1300A and a state 1300B may be referred to as the third state. For example, a state 1300C may be referred to as the second state. In the third state and the second state, a first direction 1391 toward which the first region 1331 faces may be different from a second direction 1392 toward which the second region 1332 faces. For example, in the third state and the second state, the third region 1333 may be bent at least partially.

For example, in the state 1300A, an angle between the first direction 1391 and the second direction 1392 may be about 45 degrees. For example, in the state 1300B, the angle between the first direction 1391 and the second direction 1392 may be about 150 degrees. For example, in the second state 1300C, the angle between the first direction 1391 and the second direction 1392 may be substantially 180 degrees. For example, in the state 1300A, an angle A2 between the first region 1331 and the second region 1332 may be about 135 degrees. For example, in the state 1300B, an angle A3 between the first region 1331 and the second region 1332 may be about 30 degrees. For example, in the state 1300C, an angle A4 between the first region 1331 and the second region 1332 may be substantially 0 degrees. For example, the second state may be referred to as a folded state. For example, the second state may provide the state 1300C in which the first direction 1391 is substantially opposite to the second direction 1392. For example, the state 1300C may indicate a state in which the flexible display 1330 is hidden within a field of view of a user viewing the electronic device 101. However, it is not limited thereto.

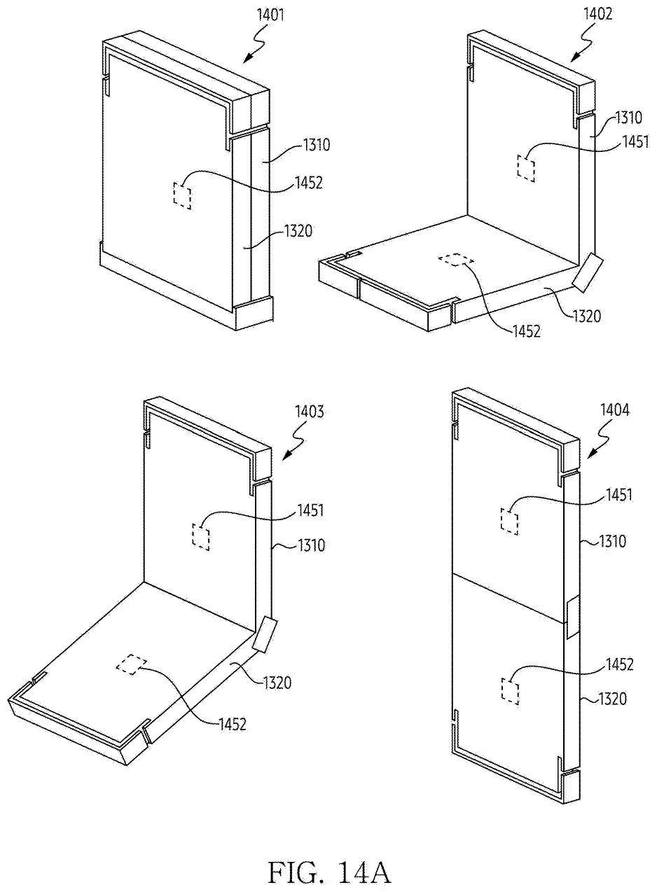

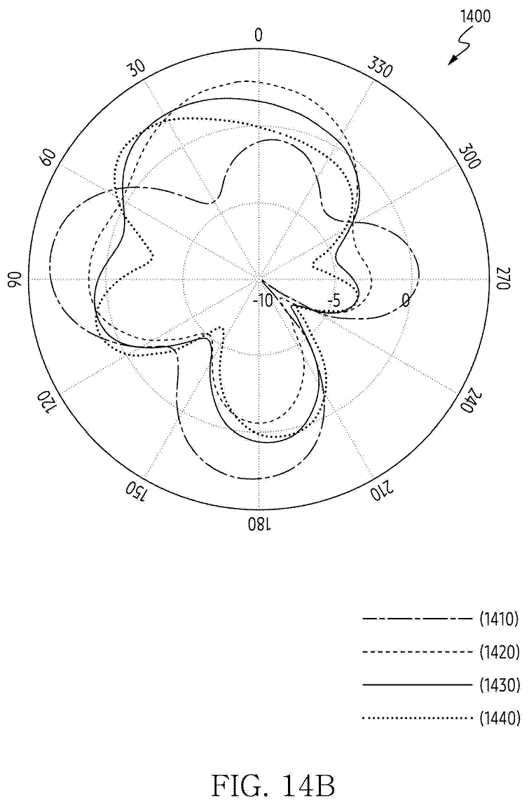

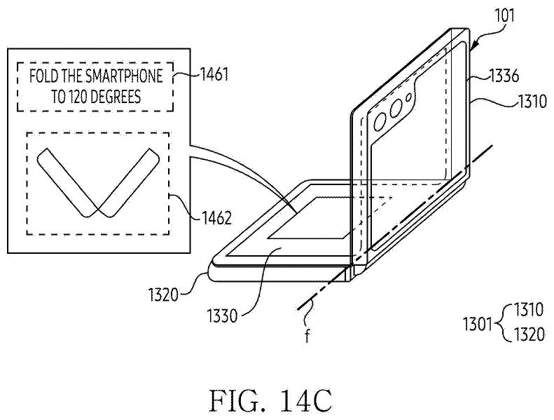

FIG. 14A illustrates states of an electronic device including a foldable housing according to an embodiment of the disclosure. FIG. 14B is a graph representing a radiation pattern of an antenna according to a state of an electronic device according to an embodiment of the disclosure. FIG. 14C illustrates an example of a screen for guiding a folding angle by an electronic device according to an embodiment of the disclosure.

For example, the electronic device 101 may include a sensor (e.g., a first sensor 1451 and/or a second sensor 1452). For example, the sensor may be used to identify a folding angle between the first housing part 1310 and the second housing part 1320. For example, the sensor may include at least one of a 6-axis sensor, a posture sensor, a geomagnetic sensor, a hall sensor, a proximity sensor, an infrared (IR) sensor, or an illuminance sensor. For example, the sensor may include the first sensor 1451 disposed in the first housing part 1310 and/or the second sensor 1452 disposed in the second housing part 1320, but it is not limited thereto.

For example, the sensor may be configured to provide, to at least one processor (e.g., the at least one processor 120 of FIG. 1), data indicating the folding angle between the first housing part 1310 and the second housing part 1320. The at least one processor 120 may be configured to identify the folding angle, based on the data provided from the sensor. The at least one processor 120 may be configured to identify whether the identified folding angle corresponds to a designated folding angle included in folding information. For example, the at least one processor 120 may be configured to maintain or stop display of the folding information displayed through the flexible display 1330, based on whether the folding angle corresponds to the designated folding angle.

Referring to FIG. 14A, the electronic device 101 may be in a first state, a second state, and a third state. For example, a state 1401 of FIG. 14A may be referred to as the second state. For example, a state 1402 and a state 1403 of FIG. 14A may be referred to as the third state. For example, a state 1404 of FIG. 14A may be referred to as the first state. According to the state of the electronic device 101, an angle between the first housing part 1310 and the second housing part 1320 may be different. For example, in the state 1401, the first housing part 1310 and the second housing part 1320 may be substantially parallel. For example, in the state 1402, the angle between the first housing part 1310 and the second housing part 1320 may be substantially a right angle (e.g., about 90 degrees). For example, in the state 1403, the angle between the first housing part 1310 and the second housing part 1320 may be an obtuse angle (e.g., about 120 degrees). For example, in the state 1402, the angle between the first housing part 1310 and the second housing part 1320 may be substantially a straight angle (e.g., about 180 degrees).

For example, based on the state of the electronic device 101, a radiation pattern of an antenna (e.g., the antenna 510 of FIG. 5B) may be different. A graph 1400 illustrated in FIG. 14B is a graph representing, on a polar coordinate system, a result of measuring a gain of the antenna 510 while rotating an elevation angle with respect to the electronic device 101 having a posture in which an azimuth angle is fixed. The gain may be a gain with respect to a signal on a designated frequency band (e.g., about 1.6 GHz).

A first graph 1410 of FIG. 14B represents a radiation pattern of the antenna 510 in a second state (e.g., the state 1401 of FIG. 14A) in which the first housing part 1310 and the second housing part 1320 are folded. A second graph 1420 of FIG. 14B represents the radiation pattern of the antenna 510 in a third state (e.g., the state 1402 of FIG. 14A) in which an angle between the first housing part 1310 and the second housing part 1320 is about 90 degrees. A third graph 1430 of FIG. 14B represents the radiation pattern of the antenna 510 in a third state (e.g., the state 1403 of FIG. 14A) in which the angle between the first housing part 1310 and the second housing part 1320 is about 120 degrees. A fourth graph 1440 of FIG. 14B represents the radiation pattern of an antenna (e.g., the antenna 510 of FIG. 5B) in a first state (e.g., the state 1404 of FIG. 14A) in which the angle between the first housing part 1310 and the second housing part 1320 is about 180 degrees.

Referring to the graph 1400, a direction and a gain of a main lobe of a radiation pattern may be different according to an angle between the first housing part 1310 and the second housing part 1320. For example, the first graph 1410 may indicate the lowest upward directivity. For example, the second graph 1420 may indicate the highest upward directivity. For example, upward directivity indicated by the third graph 1430 may be higher than upward directivity indicated by the first graph 1410. Referring to the graph 1400, upward directivity of the radiation pattern of the antenna 510 may be higher in the third state, which is an intermediate state, than in the first state or the second state.

For example, the electronic device 101 including a foldable housing (e.g., the foldable housing 1301 of FIG. 13A) may perform satellite communication. For example, when the electronic device 101 performs satellite communication, the at least one processor 120 may be configured to identify a state in which upward directivity of the radiation pattern of the antenna 510 is high and provide, through the flexible display 1330, a screen including a visual object for guiding the state.

Referring to FIG. 14C, based on the wireless communication circuitry (e.g., the wireless communication circuitry 192 of FIG. 5B) performing communication with an external electronic device (e.g., the satellite 507 of FIG. 5A) using a signal on a designated frequency band (e.g., about 1.6 GHZ), the at least one processor (e.g., the at least one processor 120 of FIG. 5B) may provide, through the flexible display 1330, a screen for guiding a state in which upward directivity of the radiation pattern of the antenna 510 is high. For example, the at least one processor 120 may display, through the flexible display 1330, a screen including text 1461 and/or an image 1462 guiding a user to adjust a folding angle. For example, the at least one processor 120 may be configured to display, through the flexible display 1330, the text 1461 such as “fold the smartphone to 120 degrees” and/or the image 1462 of the electronic device 101 folded in the state in which upward directivity is high. A user may intuitively recognize that adjustment of the folding angle is required, through the text 1461 and/or the image 1462. As the user further adjusts the folding angle by rotating the second housing part 1320 with respect to the first housing part 1310, the folding angle may correspond to a designated folding angle. The at least one processor 120 may stop display of folding information based on identifying that the folding angle corresponds to the designated folding angle by using a sensor (e.g., the first sensor 1451 and/or the second sensor 1452 of FIG. 14A).

In the above description, the folding information has been described as being displayed through the flexible display 1330, but it is not limited thereto. For example, the electronic device 101 may provide the folding information through an audio signal. For example, the electronic device 101 may provide the folding information to a user by providing an audio signal such as “fold the smartphone to 120 degrees.” In addition, the electronic device 101 may provide the folding information to the user using various methods. For example, the folding information may be displayed through a cover display 1336 distinguished from the flexible display 1330. For example, when the foldable housing 1301 is in a folded state, the electronic device 101 may display the folding information through the cover display 1336 when instructions are executed by at least one processor 120 individually or collectively. For example, the folding information may be displayed through at least one of the flexible display 1330 or the cover display 1336.

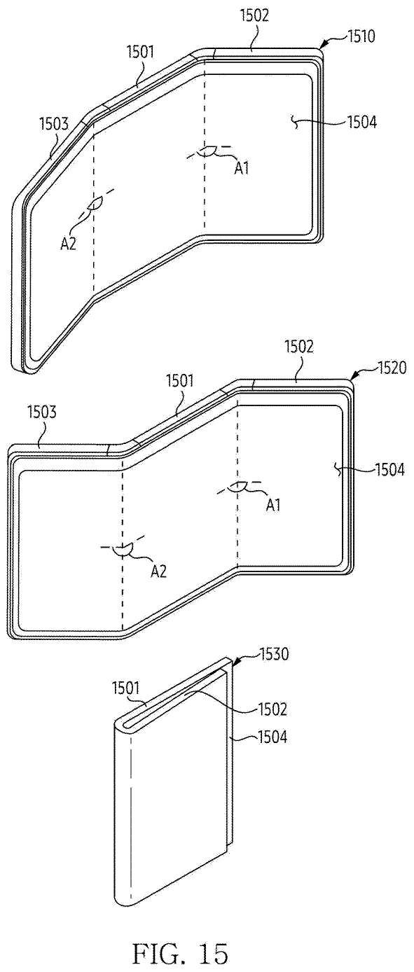

FIG. 15 illustrates electronic devices having a deformable structure according to an embodiment of the disclosure.

For example, a characteristic of identifying a state in which upward directivity of a radiation pattern of an antenna (e.g., the antenna 510 of FIG. 5B) is high and providing the state may be applied to electronic devices 101 having various structures.

For example, a device 1510 and a device 1520 of FIG. 15 may include three housing parts. For example, the three housing parts may be rotatably coupled. For example, in a case of the device 1510, a second housing part 1502 and a third housing part 1503 on both sides with respect to a first housing part 1501 located at a center may have a structure folded inward. For example, in a case of the device 1520, with respect to the first housing part 1501 located at the center, the second housing part 1502 may have a structure folded inward and the third housing part 1503 may have a structure folded outward.

For example, the device 1510 and the device 1520 of FIG. 15 may have a state in which upward directivity of the radiation pattern of the antenna 510 is high. For example, since the radiation pattern of the antenna 510 may change according to angles A1 and A2 between the three housing parts 1501, 1502, and 1503, upward directivity of the radiation pattern of the antenna 510 may increase in a specific state. For example, the at least one processor 120 may guide the state in which upward directivity of the radiation pattern of the antenna 510 is high through the flexible display 1504, in the device 1510 and the device 1520.

For example, the device 1530 of FIG. 15 may have a housing having a partially rollable structure. For example, the second housing part 1502 may be rolled with respect to the first housing part 1501. For example, when the second housing part 1502 is fully unfolded, the first housing part 1501 and the second housing part 1502 may be flat. For example, the second housing part 1502 may be rolled at least partially with respect to the first housing part 1501. The device 1530 of FIG. 15 may have a state in which upward directivity of the radiation pattern of the antenna 510 is high. For example, since the radiation pattern of the antenna may change according to a rolled length of the second housing part 1502, upward directivity of the radiation pattern of the antenna 510 may increase in a specific state. For example, the at least one processor 120 may guide the state in which the upward directivity of the device 1530 is high, through the flexible display 1504.

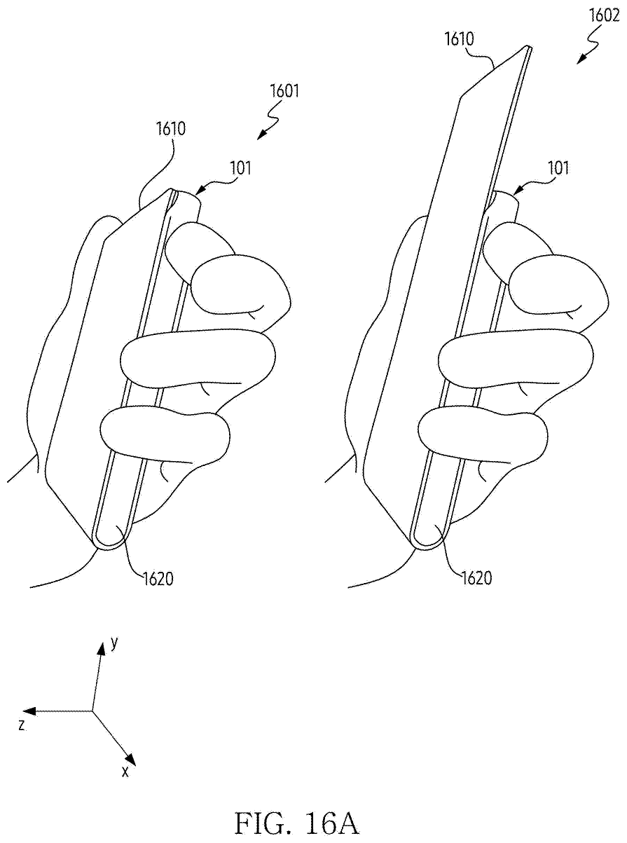

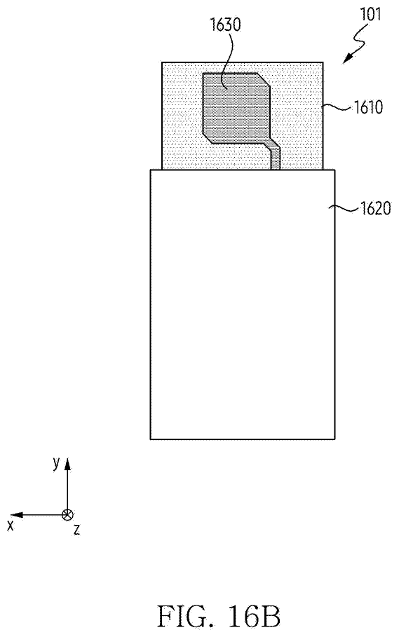

FIG. 16A illustrates states of an electronic device according to an embodiment of the disclosure. FIG. 16B illustrates a rear surface of an electronic device according to an embodiment of the disclosure.

For example, reception power received through an antenna may be calculated based on Equation 1 below.

$${P}_{R} = ( P L F ) \cdot \frac{{P}_{T} {G}_{T} {G}_{R} {c}^{2}}{{( 4 π Rf )}^{2}} \qquad Equation 1$$

(P_{T}: transmission power, G_{T}: gain of a transmission antenna, G_{R}: gain of a reception antenna, R: distance, f: frequency, PLF: polarization loss factor)

Referring to Equation 1, the reception power may depend on the polarization loss factor (PLF). The polarization loss factor is an index indicating power loss due to a difference in polarization characteristics between a transmission antenna and a reception antenna. The polarization loss factor may be “1” when the polarization characteristic of the transmission antenna and the polarization characteristic of the reception antenna correspond. The polarization loss factor may be “0” when the polarization characteristic of the transmission antenna and the polarization characteristic of the reception antenna are completely mismatched. To increase communication efficiency, correlation between the polarization characteristic of the transmission antenna and the polarization characteristic of the reception antenna may be required.

Since a circularly polarized signal has less propagation loss than a linearly polarized signal, the circularly polarized signal may be suitable for long-distance communication. Since the satellite 507 is located hundreds of kilometers to tens of thousands of kilometers above the ground on which the electronic device 101 is located, an antenna of the satellite 507 may have a circular polarization characteristic to reduce signal loss. For example, the antenna of the satellite 507 may be configured to radiate right handed circular polarization (RHCP) to increase efficiency of satellite communication. When an antenna of the electronic device 101 performing satellite communication has a circular polarization characteristic, the antenna matches the polarization characteristic of the antenna of the satellite 507, and satellite communication efficiency of the electronic device 101 may be improved.

Referring to FIG. 16A, the electronic device 101 may include a housing 1620 maintaining a fixed shape without being deformed. For example, unlike the above-described slidable housing (e.g., the slidable housing 201 of FIG. 5A) and the foldable housing (e.g., the foldable housing 1301 of FIG. 13A), the housing 1620 may maintain a bar shape and may have a structure that cannot be deformed.

For example, a flexible display 1610 may be movable. For example, a state 1601 of FIG. 16A may be referred to as a first state in which a display area of the flexible display 1610 is minimum. In the first state, a portion of the flexible display 1610 may be located on a front surface (e.g., a surface in +z direction) of the housing 1620, and another portion of the flexible display 1610 may be located on a lower surface (e.g., a surface in −y direction) and a rear surface (e.g., a surface in −z direction) of the housing 1620.

For example, a state 1602 of FIG. 16A may be referred to as a second state in which the display area of the flexible display 1610 is maximum. In the first state, another portion of the flexible display 1610 located on the lower surface and the side surface of the housing 1620 may be located at least partially on the front surface of the housing 1620 in the second state. For example, the flexible display 1610 may move in a first direction (e.g., +y direction) in the first state. As the flexible display 1610 moves in the first direction, the area of the flexible display 1610 located on the front surface of the housing 1620 may increase. For example, in the second state, the flexible display 1610 may move in a second direction (e.g., −y direction). As the flexible display 1610 moves in the second direction, the area of the flexible display 1610 located on the front surface of the housing 1620 may decrease. Although not illustrated, the electronic device 101 may be in a third state between the first state and the second state.

Referring to FIG. 16B, the electronic device 101 may include a conductive pattern 1630. For example, the conductive pattern 1630 may be formed on a surface of the flexible display 1610. For example, a surface of the flexible display 1610 on which the conductive pattern 1630 is formed may be referred to as a surface of the flexible display 1610 facing the housing 1620. For example, the surface may be a rear surface (e.g., a surface in −z direction) of the flexible display 1610.

For example, the conductive pattern 1630 may operate as an antenna radiator. For example, a polarization characteristic of the antenna 510 including the conductive pattern 1630 may be circular polarization. The electronic device 101 may have high satellite communication efficiency by radiating a circularly polarized signal through the conductive pattern 1630.

An electronic device 101 is provided. The electronic device 101 may include at least one processor 120. The electronic device 101 may include memory 130 storing instructions. The electronic device 101 may include an antenna 510. The electronic device 101 may include a slidable housing 201 including a first housing part 210 and a second housing part 220 slidably connected to the first housing part 210. The electronic device 101 may include wireless communication circuitry 192 configured to transmit a signal on a designated frequency band to an external electronic device or receive the signal from the external electronic device, through the antenna 510. The electronic device 101 may include a driving mechanism 360 configured to provide a driving force for sliding movement of the second housing part 220 with respect to the first housing part 210. The driving mechanism 360 may include a first state in which a size of the slidable housing 201 formed by the first housing part 210 and the second housing part 220 is minimum, a second state in which the size of the slidable housing 201 is maximum, and a third state between the first state and the second state. The instructions, when executed by the at least one processor 120 individually or collectively, may cause the electronic device 101 to identify, among the first state, the second state, and the third state, a state in which upward directivity of a radiation pattern of the antenna 510 is high, based on the wireless communication circuitry 192 performing communication with the external electronic device. The instructions, when executed by the at least one processor 120 individually or collectively, may cause the electronic device 101 to control the driving mechanism 360 to change the electronic device 101 to a state in which upward directivity of the radiation pattern of the antenna 510 is high.

For example, the memory 130 may store location information related to a location of the external electronic device. The instructions, when executed by the at least one processor 120 individually or collectively, may cause the electronic device 101 to obtain the location information stored in the memory 130. The instructions, when executed by the at least one processor 120 individually or collectively, may cause the electronic device 101 to identify the state in which upward directivity of the radiation pattern of the antenna 510 is high, based on the obtained location information. The instructions, when executed by the at least one processor 120 individually or collectively, may cause the electronic device 101 to control the driving mechanism 360 to change the electronic device 101 to the state in which upward directivity of the radiation pattern of the antenna 510 is high.

For example, the memory 130 may store location information related to a location of the external electronic device. The instructions, when executed by the at least one processor 120 individually or collectively, may cause the electronic device 101 to identify, at a first timing, first location information indicating a relative location of the external electronic device with respect to the electronic device 101, based on the location information stored in the memory 130. The instructions, when executed by the at least one processor 120 individually or collectively, may cause the electronic device 101 to identify, based on the first location information, a first slide-out length of the second housing part 220 with respect to the first housing part 210 corresponding to a state in which directivity of the antenna 510 faces the external electronic device. The instructions, when executed by the at least one processor 120 individually or collectively, may cause the electronic device 101 to control the driving mechanism 360 to cause sliding movement of the second housing part 220 by the first slide-out length.

For example, the instructions, when executed by the at least one processor 120 individually or collectively, may cause the electronic device 101 to identify, at a second timing after a designated time has elapsed from the first timing, second location information indicating a relative location of the external electronic device with respect to the electronic device 101, in a state in which the second housing part 220 is slid by the first slide-out length. The instructions, when executed by the at least one processor 120 individually or collectively, may cause the electronic device 101 to identify, based on the second location information, a second slide-out length of the second housing part 220 with respect to the first housing part 210 corresponding to a state in which directivity of the antenna 510 faces the external electronic device. The instructions, when executed by the at least one processor 120 individually or collectively, may cause the electronic device 101 to control the driving mechanism 360 based on a difference between the first slide-out length and the second slide-out length.

For example, the instructions, when executed by the at least one processor 120 individually or collectively, may cause the electronic device 101 to control the driving mechanism 360 to cause sliding movement of the second housing part 220 by the second slide-out length, based on a difference between the first slide-out length and the second slide-out length exceeding a threshold length.

For example, the instructions, when executed by the at least one processor 120 individually or collectively, may cause the electronic device 101 to control the driving mechanism 360 to maintain the slide-out length of the second housing part 220, based on a difference between the first slide-out length and the second slide-out length being less than or equal to the threshold length.

For example, the instructions, when executed by the at least one processor 120 individually or collectively, may cause the electronic device 101 to control the driving mechanism 360 to change the electronic device 101 to each of the first state, the second state, and the third state over a designated time, based on the wireless communication circuitry 192 performing communication with the external electronic device. The instructions, when executed by the at least one processor 120 individually or collectively, may cause the electronic device 101 to identify quality of a signal received from the external electronic device in the first state, the second state, and the third state. The instructions, when executed by the at least one processor 120 individually or collectively, may cause the electronic device 101 to control the driving mechanism 360 based on the quality of the signal.

For example, the instructions, when executed by the at least one processor 120 individually or collectively, may cause the electronic device 101 to compare quality of a first signal received in the first state, quality of a second signal received in the second state, and quality of a third signal received in the third state. The instructions, when executed by the at least one processor 120 individually or collectively, may cause the electronic device 101 to control the driving mechanism 360 based on a state of the electronic device 101 corresponding to a signal indicating the highest quality.

For example, the electronic device 101 may further include a plurality of conductive portions 530 formed along at least a portion of edges of the second housing part 220. The wireless communication circuitry 192 may be configured to communicate with the external electronic device by using at least one of the plurality of conductive portions 530.

For example, the second housing part 220 may include a first edge 551 disposed in a slide-out direction of the second housing part 220, a second edge 552 perpendicular to the first edge 551, and a third edge 553 opposite to the second edge 552.

For example, the plurality of conductive portions 530 may include a first conductive portion 531 formed between a first non-conductive portion 541 in the second edge 552 and a second non-conductive portion 542 in the first edge 551, and a second conductive portion 532 formed between the second non-conductive portion 542 and a third non-conductive portion 543 in the third edge 553.

For example, the first non-conductive portion 541 may be located closer to the first edge 551 than the third non-conductive portion 543.

For example, the second housing part 220 may further include a side frame 521 forming the first edge 551, the second edge 552, and the third edge 553. The second housing part 220 may further include a support member 520 surrounded by the side frame 521. The plurality of conductive portions 530 may include a first conductive portion 531 formed between a first non-conductive portion 541 in the second edge 552 and a second non-conductive portion 542 in the first edge 551. The plurality of conductive portions 530 may include a second conductive portion 532 formed between the second non-conductive portion 542 and a third non-conductive portion 543 in the first edge 551. The plurality of conductive portions 530 may include a third conductive portion 533 formed between the third non-conductive portion 543 and a fourth non-conductive portion 544 in the third edge 553. The plurality of conductive portions 530 may include a fourth conductive portion 534 formed between the first non-conductive portion 541 and a point at which the side frame 521 contacts the support member 520.

For example, the plurality of conductive portions 530 may include a first conductive portion 531 formed between a first non-conductive portion 541 in the second edge 552 and a second non-conductive portion 542 in the second edge 552. The plurality of conductive portions 530 may include a second conductive portion 532 formed between the second non-conductive portion 542 and a third non-conductive portion 543 in the first edge 551. The plurality of conductive portions 530 may include a third conductive portion 533 formed between the third non-conductive portion 543 and a fourth non-conductive portion 544 in the first edge 551. The plurality of conductive portions 530 may include a fourth conductive portion 534 formed between the fourth non-conductive portion 544 and a fifth non-conductive portion 545 in the third edge 553. The plurality of conductive portions 530 may include a fifth conductive portion 535 formed between the fifth non-conductive portion 545 and a sixth non-conductive portion 546 in the third edge 553.

For example, the wireless communication circuitry 192 may be configured to communicate with the external electronic device by using a conductive portion formed at least partially in the first edge 551 among the plurality of conductive portions 530.

For example, the designated frequency band may include a satellite communication frequency band. The external electronic device may include a satellite 507.

For example, the memory 130 may store location information related to a location of the external electronic device. The electronic device 101 may further include a flexible display 1610 disposed on the slidable housing 201. The at least one processor 120 may be configured to guide a location of the electronic device 101 aligned with the external electronic device through the flexible display 1610, based on the location information stored in the memory 130.

An electronic device 101 is provided. The electronic device 101 may include at least one processor 120. The electronic device 101 may include an antenna 510. The electronic device 101 may include wireless communication circuitry 192 configured to communicate with an external electronic device by using a signal on a designated frequency band. The electronic device 101 may include a foldable housing 1301 including a first housing part 1310 and a second housing part 1320. The electronic device 101 may include a flexible display 1610 including a first region disposed on the first housing part 1310, a second region disposed on the second housing part 1320, and a third region between the first region and the second region. The electronic device 101 may include a hinge structure 1365, rotatably connecting the first housing part 1310 and the second housing part 1320 with respect to a folding axis, configured to provide a first state in which a first direction toward which the first region faces corresponds to a second direction toward which the second region faces, a second state in which the first direction is opposite to the second direction, and a third state between the second state and the first state. The instructions, when executed by the at least one processor 120 individually or collectively, may cause the electronic device 101 to identify an angle between the first region 1331 and the second region 1332 in which a state in which upward directivity of the radiation pattern of the antenna 510 is high, based on the wireless communication circuitry 192 performing communication with the external electronic device by using the signal on the designated frequency band. The instructions, when executed by the at least one processor 120 individually or collectively, may cause the electronic device 101 to display, through the flexible display 1330, a screen for guiding the identified angle.

For example, the electronic device 101 may further include sensors 1451 and 1452 configured to provide, to the at least one processor 120, data indicating a folding angle between the first region 1331 and the second region 1332.

For example, the instructions, when executed by the at least one processor 120 individually or collectively, may cause the electronic device 101 to stop display of the screen based on identifying that the folding angle corresponds to the angle in which upward directivity of the radiation pattern of the antenna 510 is high.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

No claim element is to be construed under the provisions of 35 U.S.C. § 112, sixth paragraph, unless the element is expressly recited using the phrase “means for” or “means.”

What is claimed is:

1. An electronic device comprising:
at least one processor comprising processing circuitry;
memory comprising one or more storage media storing instructions;
an antenna;
a slidable housing including a first housing part and a second housing part slidably coupled to the first housing part;
wireless communication circuitry configured to transmit a signal on a designated frequency band to an external electronic device through the antenna or receive the signal from the external electronic device through the antenna;
a driving mechanism configured to provide a driving force for sliding movement of the second housing part with respect to the first housing part,
wherein the driving mechanism is configured to provide:
a first state, in which a size of the slidable housing formed by the first housing part and the second housing part is minimum,
a second state, in which the size of the slidable housing is maximum, and
a third state, in which the size of the slidable housing is in between that of the first state and that of the second state, and
wherein the instructions, when executed by the at least one processor individually or collectively, cause the electronic device to:
based on the wireless communication circuitry performing communication with the external electronic device, identify, from among the first state, the second state, and the third state, a state in which upward directivity of a radiation pattern of the antenna is high, and
control the driving mechanism to change a state of the electronic device to the state in which the upward directivity of the radiation pattern of the antenna is high.

2. The electronic device of claim 1,
wherein the memory stores location information related to a location of the external electronic device, and
wherein the instructions, when executed by the at least one processor individually or collectively, cause the electronic device to:
obtain the location information stored in the memory,
identify, based on the obtained location information, the state in which the upward directivity of the radiation pattern of the antenna is high, and
control the driving mechanism to change the state of the electronic device to the state in which the upward directivity of the radiation pattern of the antenna is high.

3. The electronic device of claim 1,
wherein the memory stores location information related to a location of the external electronic device, and
wherein the instructions, when executed by the at least one processor individually or collectively, cause the electronic device to:
based on the location information stored in the memory, identify, at a first timing, first location information indicating a relative location of the external electronic device with respect to the electronic device,
identify, based on the first location information, a first slide-out length of the second housing part with respect to the first housing part corresponding to a state in which directivity of the antenna is directed toward the external electronic device, and
control the driving mechanism to cause sliding movement of the second housing part by the first slide-out length.

4. The electronic device of claim 3,
wherein the instructions, when executed by the at least one processors individually or collectively, cause the electronic device to:
while a state in which the second housing part is slid by the first slide-out length, identify, at a second timing after a designated time has elapsed from the first timing, second location information indicating the relative location of the external electronic device with respect to the electronic device,
identify, based on the second location information, a second slide-out length of the second housing part with respect to the first housing part corresponding to a state in which the directivity of the antenna is directed toward the external electronic device, and
control the driving mechanism based on a difference between the first slide-out length and the second slide-out length.

5. The electronic device of claim 4,
wherein the instructions, when executed by the at least one processor individually or collectively, cause the electronic device to control the driving mechanism to cause sliding movement of the second housing part by the second slide-out length, based on the difference between the first slide-out length and the second slide-out length exceeding a threshold length.

6. The electronic device of claim 4,
wherein the instructions, when executed by the at least one processor individually or collectively, cause the electronic device to control the driving mechanism to maintain a slide-out length of the second housing part based on the difference between the first slide-out length and the second slide-out length being equal to or less than a threshold length.

7. The electronic device of claim 1,
wherein the instructions, when executed by the at least one processors individually or collectively, cause the electronic device to:
based on the wireless communication circuitry performing the communication with the external electronic device, control the driving mechanism to change the electronic device to each of the first state, the second state, and the third state over a designated time,
identify, in each of the first state, the second state, and the third state, a quality of the signal received from the external electronic device; and
control the driving mechanism based on the quality of the signal.

8. The electronic device of claim 7,
wherein the instructions, when executed by the at least one processors individually or collectively, cause the electronic device to:
compare the quality of a first signal received in the first state, the quality of a second signal received in the second state, and the quality of a third signal received in the third state; and
control the driving mechanism based on a state of the electronic device corresponding to a signal having highest quality.

9. The electronic device of claim 1, further comprising a plurality of conductive portions formed along at least a portion of edges of the second housing part,
wherein the wireless communication circuitry is configured to communicate with the external electronic device using at least one of the plurality of conductive portions.

10. The electronic device of claim 9,
wherein the second housing part includes:
a first edge disposed in a slide-out direction of the second housing part;
a second edge perpendicular to the first edge; and
a third edge opposite to the second edge.

11. The electronic device of claim 10,
wherein the plurality of conductive portions include:
a first conductive portion formed between a first non-conductive portion in the second edge and a second non-conductive portion in the first edge; and
a second conductive portion formed between the second non-conductive portion and a third non-conductive portion in the third edge.

12. The electronic device of claim 11,
wherein the first non-conductive portion is positioned closer to the first edge than the third non-conductive portion.

13. The electronic device of claim 10,
wherein the second housing part further includes:
a side frame forming the first edge, the second edge, and the third edge; and
a support member surrounded by the side frame,
wherein the plurality of conductive portions include:
a first conductive portion formed between a first non-conductive portion in the second edge and a second non-conductive portion in the first edge,
a second conductive portion formed between the second non-conductive portion and a third non-conductive portion in the first edge,
a third conductive portion formed between the third non-conductive portion and a fourth non-conductive portion in the third edge, and
a fourth conductive portion formed between the first non-conductive portion and a point at which the side frame contacts the support member.

14. The electronic device of claim 10,
wherein the plurality of conductive portions include:
a first conductive portion formed between a first non-conductive portion in the second edge and a second non-conductive portion in the second edge,
a second conductive portion formed between the second non-conductive portion and a third non-conductive portion in the first edge,
a third conductive portion formed between the third non-conductive portion and a fourth non-conductive portion in the first edge,
a fourth conductive portion formed between the fourth non-conductive portion and a fifth non-conductive portion in the third edge, and
a fifth conductive portion formed between the fifth non-conductive portion and a sixth non-conductive portion in the third edge.

15. The electronic device of claim 10,
wherein the wireless communication circuitry is configured to communicate with the external electronic device using a conductive portion of the plurality of conductive portions that is at least partially formed on the first edge.

16. The electronic device of claim 1,
wherein the designated frequency band includes a satellite communication frequency band, and
wherein the external electronic device includes a satellite.

17. The electronic device of claim 1, further comprising a flexible display coupled to the slidable housing,
wherein the memory stores location information related to a location of the external electronic device, and
wherein the instructions, when executed by the at least one processor individually or collectively, cause the electronic device to guide a location of the electronic device aligned with the external electronic device through the flexible display, based on the location information stored in the memory.

18. An electronic device comprising:
memory, including one or more storage media, storing instructions;
an antenna;
wireless communication circuitry configured to communicate with an external electronic device using a signal on a designated frequency band;
a foldable housing including a first housing part and a second housing part rotatably coupled to the first housing part;
a flexible display including a first portion disposed on the first housing part, a second portion disposed on the second housing part, and third portion between the first portion and the second portion;
a hinge structure rotatably connecting the first housing part and the second housing part with respect to a folding axis; and
one or more processors, including processing circuitry, communicatively coupled to the wireless communication circuitry and the memory,
wherein the hinge structure is configured to transition the electronic device among:
a first state, in which a first direction in which the first portion faces is the same as a second direction in which the second portion faces,
a second state, in which the first direction is opposite to the second direction, and
a third state, which is between the second state and the first state, and
wherein the instructions, when executed by the one or more processors individually or collectively, cause the electronic device to:
based on the wireless communication circuitry performing communication with the external electronic device, identify an angle between the first portion and the second portion in which upward directivity of a radiation pattern of the antenna is high, and
display a screen on the flexible display for guiding the angle in which the upward directivity of the radiation pattern of the antenna is high.

19. The electronic device of claim 18, further comprising a sensor configured to provide data indicating an angle between the first portion and the second portion to the one or more processors.

20. The electronic device of claim 19,
wherein the instructions, when executed by the one or more processors individually or collectively, cause the electronic device to stop displaying the screen, based on identifying that the angle indicated by the data corresponds to the angle in which the upward directivity of a radiation pattern of the antenna is high.
